(19) United States
(12) Patent Application Publication
(10) Pub. No.: US 2025/0120403 A1
(43) Pub. Date: Apr. 17, 2025

(54) MYCORRIHIZAL COMPOSITIONS AND RELATED METHODS OF MANUFACTURE AND USE

(71) Applicant: VERDESIAN LIFE SCIENCES U.S., LLC, Cary, NC (US)

(72) Inventors: Dinesh ADHIKARI, Cary, NC (US); Kuide QIN, Cary, NC (US); Amy BURTON, Cary, NC (US)

(21) Appl. No.: 18/918,833

(22) Filed: Oct. 17, 2024

Related U.S. Application Data
(63) Continuation of application No. PCT/US2024/050850, filed on Oct. 10, 2024.
(60) Provisional application No. 63/589,830, filed on Oct. 12, 2023.

(51) Int. Cl. A01N 63/30; A01N 25/08; A01N 63/20; A01P 21/00

(52) U.S. Cl. CPC A01N 63/30; A01N 25/08; A01N 63/20; A01P 21/00

(57) ABSTRACT

Compositions include a mycorrhizal fungi component and a biostimulant component. Methods include combining the mycorrhizal fungi component with the biostimulant component and/or applying the composition to soil or to a seed, seedling, or plant.

### BACKGROUND

### 1. Technical Field

The present disclosure relates to novel compositions containing mycorrhizal fungi and methods of manufacturing and using the same. In particular, the present disclosure relates to synergistic combinatorial products comprising one or more (i) mycorrhizal fungi (or mycorrhizal fungal species) and (ii) biostimulant(s), and specifically, synergistic combinations of one or more mycorrhizal fungi with biostimulant(s) and optional nutrient(s), which can be useful for improving plant growth and/or plant yield when applied to the plant (or plantlet), seed, or soil (associated with the plant or seed).

### 2. Related Technology

Mycorrhizal fungi form a symbiotic association with plants. Mycorrhizac play important roles in plant nutrition and soil health. In this association, plants provide organic molecules such as carbohydrates to the mycorrhizal fungus and the fungus supplies the plant with water and nutrients such as phosphorus taken from the soil. In addition to this, mycorrhizae provide other benefits to plants, such as improved drought and salinity tolerance.

Alternatively, plant biostimulants, such as humic acid or fulvic acid, seaweed extracts, protein hydrolysates, etc. may be used to improve nutrient use efficiency, tolerance to abiotic stresses, and plant quality traits.

Using biostimulants in combination with mycorrhizal fungi can be challenging, as the live/active fungi can be negatively affected by the addition of otherwise plant-beneficial products and processes. Accordingly, there remains a strong need for a product that provides the benefits of mycorrhizal fungi and the benefits of plant biostimulants, without one component having a detrimental effect on the use of the other product, and preferably with enhanced beneficial effects.

### BRIEF SUMMARY

Embodiments of the present disclosure solve one or more of the foregoing or other problems in the art with novel compositions containing mycorrhizal fungi and methods of manufacturing and using the same. In particular, embodiments of the present disclosure include combinatorial products comprising one or more mycorrhizal fungi and biostimulant(s), and specifically, synergistic combinations of one or more mycorrhizal fungi with biostimulant(s) and optional nutrient(s), which can be useful for improving plant growth and/or plant yield when applied to the plant (or plantlet), seed, or soil (associated with the plant or seed).

The synergistic combinations can produce plant growth and/or other results or effects that are greater than additive—i.e., greater than the sum of the plant growth and/or other result or effect of (i) the one or more mycorrhizal fungi, alone, and (ii) the biostimulant(s) and optional nutrient(s), alone.

Illustrative embodiments of the present disclosure can include a combinatorial product (mixture) that can be applied to a plant (or plantlet), seed (or seedling), or soil (associated with the plant or seed), or a system (kit) comprising a plurality of products that can be co-applied to a plant (or plantlet), seed (or seedling), or soil (associated with the plant or seed). The combinatorial product or system can comprise a mycorrhizal fungal component (or product), comprising one or more mycorrhizal fungi, a biostimulant component (or product), comprising one or more biostimulant(s), and an optional nutrient component (or product), comprising one or more nutrient(s). The optional nutrient component (or product) can optionally be mixed with or part of the biostimulant component (or product).

The components of the combinatorial product or system can each be in solid form (e.g., granular, powdered, particulate, or combinations thereof) or liquid form (e.g., solution, suspension, emulsion, colloid, or combinations thereof). In some (solid form) embodiments, the composition and/or one or more components thereof have a moisture content less than or equal to about 20%, by weight, or between about 0.025% and about 20%, by weight, preferably less than or equal to about 15%, by weight, or between about 0.025% and about 15%, by weight, more preferably less than or equal to about 10%, by weight, or between about 0.025% and about 10%, by weight, still more preferably less than or equal to about 8%, by weight, or between about 0.025% and about 8%, by weight, still more preferably less than or equal to about 5%, by weight, or between about 0.025% and about 5%, by weight, still more preferably less than or equal to about 3%, by weight, or between about 0.025% and about 3%, by weight.

Illustrative embodiments include a composition, comprising: a mycorrhizal fungi component comprising one or more fungal species; and a biostimulant component.

In at least one aspect or embodiment of the present disclosure, the mycorrhizal fungi component (or product) comprises one or more fungal species. Non-limiting examples of fungal species include: Glomus sp., Gigaspora sp., Scutellospora sp., Acaulospora sp., Entrophospora sp., Rhizophagus sp., and Claroldeoglomus sp. fungi. In some embodiments, the mycorrhizal fungi component (or product) can include one or more species of Rhizophagus, more preferably Rhizophagus irregularis, Rhizophagus aggregatus, and/or Rhizophagus clarus. In some embodiments, the mycorrhizal fungi component (or product) can include one or more species of Claroideoglomus, preferably Claroideoglomus etunicatum. In some embodiments, the mycorrhizal fungi component (or product) can include one or more species of Glomus, preferably Glomus intraradices and/or Glomus mosseae. In some embodiments, the mycorrhizal fungi component (or product) can include two or more species of fungi.

In some embodiments, the one or more fungal species is selected from the group consisting of Glomus sp., Gigaspora sp., Scutellospora sp., Acaulospora sp., Entrophospora sp., Rhizophagus sp., and Claroldeoglomus sp. In some embodiments, the one or more fungal species comprise Rhizophagus sp., preferably Rhizophagus irregularis, Rhizophagus aggregatus, and/or Rhizophagus clarus. In some embodiments, the one or more fungal species comprise Claroideoglomus sp., preferably Claroideoglomus etunicatum. In some embodiments, the one or more fungal species comprise Rhizophagus sp., preferably Rhizophagus irregularis, Rhizophagus aggregatus, and/or Rhizophagus clarus, and Claroideoglomus sp., preferably Claroideoglomus etunicatum. In some embodiments, the one or more fungal species comprise Glomus sp., preferably Glomus intraradices and/or Glomus mosseae.

In some embodiments, the one or more fungal species is selected from the group consisting of Glomus sp., Gigaspora sp., Scutellospora sp., Acaulospora sp., Entrophospora sp., Rhizophagus sp., and Claroldeoglomus sp.

In some embodiments, the one or more fungal species is bound or adsorbed to a surface of a solid carrier and/or absorbed below the surface of the solid carrier. In some embodiments, the solid carrier can be or comprise a powdered or granular composition. In some embodiments, the solid carrier can be selected from the group consisting of humic acid(s), fulvic acid, diatomaceous earth, one or more phyllosilicates, clay, one or more naturally-occurring earth components, plant material, seaweed or extract(s) thereof, chitosan(s), pyroglutamic acid, and various combination(s) thereof. In at least one embodiment, the solid carrier can be or comprise one or more phyllosilicates, clay, or naturally-occurring earth components. In at least one embodiment, the solid carrier can be or comprise diatomaceous earth. In some embodiments, the solid carrier component comprises talc, bentonite, and/or humic acid(s). In some embodiments, the solid carrier component comprises a plant material or plant extract(s).

In some embodiments, the one or more fungal species is (also) bound or adsorbed to a surface of a solid carrier and/or absorbed below the surface of the solid carrier, wherein the solid carrier is optionally selected from the group consisting of diatomaceous earth, one or more phyllosilicates, preferably clay, and one or more naturally-occurring earth components.

Illustrative compositions can include a mycorrhizal fungi component comprising one or more fungal species bound or adsorbed to a surface of a solid carrier and/or absorbed below the surface of the solid carrier; and a biostimulant component comprising a solid carrier component and a microbial fermentation product (e.g., a bacterial fermentation product) adsorbed to a surface of the solid carrier component and/or absorbed below the surface of the solid carrier component, the microbial fermentation product comprising: lysed microorganisms (e.g., bacteria); fermentation medium; and fermentation metabolites.

In some embodiments, the (solid) carrier has a moisture content less than or equal to about 20%, by weight, or between about 0.025% and about 20%, by weight, preferably less than or equal to about 15%, by weight, or between about 0.025% and about 15%, by weight, more preferably less than or equal to about 10%, by weight, or between about 0.025% and about 10%, by weight, still more preferably less than or equal to about 8%, by weight, or between about 0.025% and about 8%, by weight, still more preferably less than or equal to about 5%, by weight, or between about 0.025% and about 5%, by weight, still more preferably less than or equal to about 3%, by weight, or between about 0.025% and about 3%, by weight.

In some embodiments, the mycorrhizal fungi component has a moisture content less than or equal to about 20%, by weight, or between about 0.025% and about 20%, by weight, preferably less than or equal to about 15%, by weight, or between about 0.025% and about 15%, by weight, more preferably less than or equal to about 10%, by weight, or between about 0.025% and about 10%, by weight, still more preferably less than or equal to about 8%, by weight, or between about 0.025% and about 8%, by weight, still more preferably less than or equal to about 5%, by weight, or between about 0.025% and about 5%, by weight, still more preferably less than or equal to about 3%, by weight, or between about 0.025% and about 3%, by weight.

In at least one aspect or embodiment of the present disclosure, the biostimulant component (or product) disclosed herein comprise at least one biostimulant. Non-limiting examples of biostimulants include: microbial (e.g., bacterial) fermentation (whole culture lysate) products, humic acid(s), fulvic acid, seaweed extract(s), protein hydrolysate(s), chitosan(s), pyroglutamic acid, etc., and various combination(s) thereof. In at least one aspect or embodiment of the present disclosure, the biostimulant component can comprise lysed microorganisms; fermentation medium; and fermentation metabolites. Illustratively, the biostimulant component can comprise a whole culture lysate of a microbial (e.g., bacterial) fermentation culture. Alternatively, or in addition, the biostimulant component can comprise humic acid(s). Alternatively, or in addition, the biostimulant component can comprise fulvic acid, seaweed extract(s), protein hydrolysate(s), chitosan(s), pyroglutamic acid, etc.

In some embodiments, the solid carrier can be or comprise a powdered or granular composition. In some embodiments, the solid carrier can be selected from the group consisting of humic acid(s), fulvic acid, diatomaceous earth, one or more phyllosilicates, clay, one or more naturally-occurring earth components, plant material, seaweed or extract(s) thereof, chitosan(s), pyroglutamic acid, and various combination(s) thereof. In at least one embodiment, the solid carrier can be or comprise a mixture of (i) one or more phyllosilicates, clay, or naturally-occurring earth components and (ii) humic acid(s). In at least one embodiment, the solid carrier can be or comprise a mixture of (i) one or more phyllosilicates, clay, or naturally-occurring earth components, (ii) humic acid(s), and fulvic acid.

In some embodiments, the (solid) carrier has a moisture content less than or equal to about 20%, by weight, or between about 0.025% and about 20%, by weight, preferably less than or equal to about 15%, by weight, or between about 0.025% and about 15%, by weight, more preferably less than or equal to about 10%, by weight, or between about 0.025% and about 10%, by weight, still more preferably less than or equal to about 8%, by weight, or between about 0.025% and about 8%, by weight, still more preferably less than or equal to about 5%, by weight, or between about 0.025% and about 5%, by weight, still more preferably less than or equal to about 3%, by weight, or between about 0.025% and about 3%, by weight.

In some embodiments, the biostimulant(s) (component) has a moisture content less than or equal to about 20%, by weight, or between about 0.025% and about 20%, by weight, preferably less than or equal to about 15%, by weight, or between about 0.025% and about 15%, by weight, more preferably less than or equal to about 10%, by weight, or between about 0.025% and about 10%, by weight, still more preferably less than or equal to about 8%, by weight, or between about 0.025% and about 8%, by weight, still more preferably less than or equal to about 5%, by weight, or between about 0.025% and about 5%, by weight, still more preferably less than or equal to about 3%, by weight, or between about 0.025% and about 3%, by weight.

In some embodiments, less than about 50%, by weight, or between about 1% and about 50%, by weight of biomass in the microbial fermentation product is living or viable microorganisms. In some embodiments, less than about 20%, by weight, or between about 1% and about 20%, by weight of biomass in the microbial fermentation product is living or viable microorganisms. In some embodiments, less than about 10%, by weight, or between about 1% and about 10%, by weight of biomass in the microbial fermentation product is living or viable microorganisms. In some embodiments, less than about 5%, by weight, or between about 1% and about 5%, by weight of biomass in the microbial fermentation product is living or viable microorganisms. In some embodiments, less than about 1%, by weight, or between about 0.01% and about 1%, by weight of biomass in the microbial fermentation product is living or viable microorganisms. In some embodiments, the microbial fermentation product is entirely or substantially devoid of living and/or viable microorganisms.

In some embodiments, the microbial fermentation product comprises a whole culture lysate (of a microbial (e.g., bacterial) fermentation culture. In some embodiments, the lysed microorganisms comprise lysed bacteria, preferably lysed lactic acid bacteria, more preferably lysed Lactobacillus sp. bacteria, and optionally one or more additional microbial species or strains.

In some embodiments, the composition further comprises at least one additional component selected from the group consisting of: one or more minerals or nutrients, preferably selected from the group consisting of zinc, zinc sulfate, zinc oxide, magnesium, magnesium oxide, calcium, and calcium oxide; and one or more spreading agents, preferably selected from the group consisting of corn starch, plant starch, plant fiber, diatomaceous earth, one or more phyllosilicates, and one or more naturally-occurring earth components.

Illustrative compositions can include a mycorrhizal fungi component comprising one or more fungal species; and a biostimulant component comprising a solid carrier component and a microbial fermentation product adsorbed to a surface of the solid carrier component and/or absorbed below the surface of the solid carrier component, the microbial fermentation product comprising: lysed microorganisms; fermentation medium; and fermentation metabolites.

Illustrative compositions can include (i) a mycorrhizal fungi component comprising one or more fungal species bound or adsorbed to a surface of a solid carrier and/or absorbed below the surface of the solid carrier, wherein the solid carrier is selected from the group consisting of diatomaceous earth, clay, one or more phyllosilicates, and one or more naturally-occurring earth components, and wherein the one or more fungal species is selected from the group consisting of Glomus sp., Gigaspora sp., Scutellospora sp., Acaulospora sp., Entrophospora sp., Rhizophagus sp., and Claroldeoglomus sp., and optionally further comprises one or more spreading agents, preferably selected from the group consisting of corn starch, plant starch, plant fiber, diatomaceous earth, one or more phyllosilicates, and one or more naturally-occurring earth components; and (ii) a biostimulant component comprising a solid carrier component and a microbial fermentation product adsorbed to a surface of the solid carrier component and/or absorbed below the surface of the solid carrier component, the microbial fermentation product comprising a whole culture lysate, comprising: lysed microorganisms; fermentation medium; and fermentation metabolites, wherein less than about 50%, by weight, of biomass in the microbial fermentation product is living or viable microorganisms, and wherein the solid carrier component is selected from the group consisting of one or more phyllosilicates, one or more naturally-occurring earth components, talc, bentonite, humic acid(s), plant material(s), plant extract(s), and combination(s) thereof; and at least one additional component selected from the group consisting of: one or more minerals or nutrients, preferably selected from the group consisting of zinc, zinc sulfate, zinc oxide, magnesium, magnesium oxide, calcium, and calcium oxide, wherein the composition has a moisture content less than or equal to about 20%, by weight, preferably less than or equal to about 15%, by weight, more preferably less than or equal to about 10%, by weight, still more preferably less than or equal to about 8%, by weight, still more preferably less than or equal to about 5%, by weight, still more preferably less than or equal to about 3%, by weight.

In some embodiments, the one or more fungal species comprise Rhizophagus sp., preferably Rhizophagus irregularis, Rhizophagus aggregatus, and/or Rhizophagus clarus. In some embodiments, the one or more fungal species comprise Claroideoglomus sp., preferably Claroideoglomus etunicatum. In some embodiments, the one or more fungal species comprise Rhizophagus sp., preferably Rhizophagus irregularis, Rhizophagus aggregatus, and/or Rhizophagus clarus, and Claroideoglomus sp., preferably Claroideoglomus etunicatum. In some embodiments, the one or more mycorrhizal species comprise Glomus sp., preferably Glomus intraradices and/or Glomus mosseae.

In some embodiments, less than about 1%, by weight, of biomass in the microbial fermentation product is living or viable microorganisms. In some embodiments, the lysed microorganisms comprise lysed lactic acid bacteria, preferably lysed Lactobacillus sp. bacteria, and optionally one or more additional microbial species or strains.

In some embodiments, the composition, kit, or system can one or more beneficial microorganisms, such as Rhizobia sp. and/or Azospirillum sp.

At least one aspect or embodiment of the present disclosure can include a method, comprising applying the composition (as described herein) to soil or to a seed, seedling, or plant.

At least one aspect or embodiment of the present disclosure can include a method of manufacturing a composition, the method comprising combining a mycorrhizal fungi component comprising one or more fungal species with a biostimulant component comprising: lysed microorganisms; fermentation medium; and fermentation metabolites.

In some embodiments, the mycorrhizal fungi component and the biostimulant component are each in a dry or solid form. In some embodiments, the biostimulant component comprising a solid carrier component and a microbial fermentation product adsorbed to a surface of the solid carrier component and/or absorbed below the surface of the solid carrier component, the microbial fermentation product comprising: the lysed microorganisms; the fermentation medium; and the fermentation metabolites, wherein the solid carrier component is optionally selected from the group consisting of one or more phyllosilicates, one or more naturally-occurring earth components, talc, bentonite, humic acid(s), plant material(s), plant extract(s), and combination(s) thereof.

In some embodiments, the mycorrhizal fungi component comprises the one or more fungal species is bound or adsorbed to a surface of a solid carrier and/or absorbed below the surface of the solid carrier, wherein the solid carrier is optionally selected from the group consisting of diatomaceous earth, one or more phyllosilicates, preferably clay, and one or more naturally-occurring earth components.

In some embodiments, the composition has a moisture content less than or equal to about 20%, by weight, preferably less than or equal to about 15%, by weight, more preferably less than or equal to about 10%, by weight, still more preferably less than or equal to about 8%, by weight, still more preferably less than or equal to about 5%, by weight, still more preferably less than or equal to about 3%, by weight.

In some embodiments, the one or more fungal species is selected from the group consisting of Glomus sp., Gigaspora sp., Scutellospora sp., Acaulospora sp., Entrophospora sp., Rhizophagus sp., and Claroldeoglomus sp. In some embodiments, the one or more fungal species comprises: Rhizophagus sp., more preferably Rhizophagus irregularis, Rhizophagus aggregatus, and/or Rhizophagus clarus; Claroideoglomus sp., preferably Claroideoglomus etunicatum; and/or Glomus sp., preferably Glomus intraradices and/or Glomus mosseae.

In some embodiments, less than about 50%, by weight, of biomass in the microbial fermentation product is living or viable microorganisms, preferably wherein less than about 1%, by weight, of biomass in the microbial fermentation product is living or viable microorganisms.

In some embodiments, the composition further comprises at least one additional component selected from the group consisting of: one or more minerals or nutrients, preferably selected from the group consisting of zinc, zinc sulfate, zinc oxide, magnesium, magnesium oxide, calcium, and calcium oxide; and one or more spreading agents, preferably selected from the group consisting of corn starch, plant starch, plant fiber, diatomaceous earth, one or more phyllosilicates, and one or more naturally-occurring earth components.

Illustrative methods of manufacturing a composition can include: forming a biostimulant component by applying a microbial fermentation product in liquid form to a solid carrier component such that the fermentation product is adsorbed to the surface of the solid carrier and/or absorbed below the surface of the solid carrier; and mixing the biostimulant component with a mycorrhizal fungi component comprising one or more fungal species.

Illustrative methods of manufacturing a composition can include: forming a biostimulant component by: (i) obtaining a solid carrier component, the solid carrier component preferably comprising a dry, powdered, and/or granular composition comprising one or more phyllosilicates, diatomaceous earth, one or more naturally-occurring earth components, and/or humic acid(s); (ii) (forming a biostimulant component by) applying a microbial fermentation product in liquid form to the solid carrier component such that the fermentation product is adsorbed to the surface of the solid carrier and/or absorbed below the surface of the solid carrier, the microbial fermentation product preferably comprising a whole culture lysate, comprising: lysed microorganisms; fermentation medium; and fermentation metabolites; allowing the solid carrier component with microbial fermentation product applied thereto to dry to a moisture content below about 20% (etc.), by weight; and optionally mixing the solid carrier component with microbial fermentation product applied thereto and having a moisture content below about 20% (etc.), by weight, with one or more nutrients, in dry, solid, powdered, and/or granular form, preferably having a moisture content below about 20% (etc.), by weight, the one or more nutrients preferably selected from the group consisting of zinc, zinc sulfate, zinc oxide, magnesium, magnesium oxide, calcium, and calcium oxide; and (iii) combining the biostimulant component with a mycorrhizal fungi component in dry, solid, powdered, and/or granular form, the mycorrhizal fungi component preferably having a moisture content below about 10%, by weight, the mycorrhizal fungi component comprising one or more fungal species, preferably selected from the group consisting of Glomus sp., Gigaspora sp., Scutellospora sp., Acaulospora sp., Entrophospora sp., Rhizophagus sp., and Claroldeoglomus sp.

In some embodiments, the microbial fermentation product is applied in liquid form to the solid carrier component in a manner that prevents or avoids (i) oversaturating the solid carrier component with the liquid and/or (ii) causing the solid carrier component to become muddy, such as by adding the liquid too quickly. In some embodiments, the microbial fermentation product is applied in liquid form to the solid carrier component by spray-drying. In some embodiments, the microbial fermentation product is applied in liquid form to the solid carrier component in multiple applications, wherein the step of allowing the solid carrier component with microbial fermentation product applied thereto to dry to a moisture content below about 20% (etc.), by weight, is performed after each application. In some embodiments, the multiple applications include at least four separate applications. In some embodiments, a first application applies about 30% of the microbial fermentation product to the solid carrier component, a second application applies about 30% of the microbial fermentation product to the solid carrier component, a third application applies about 20% of the microbial fermentation product to the solid carrier component, and a fourth application applies about 20% of the microbial fermentation product to the solid carrier component.

In some embodiments, the method further comprises grinding, crushing, and/or milling the biostimulant component prior to combining the biostimulant component with the mycorrhizal fungi component.

In some embodiments, the method further comprises obtaining the mycorrhizal fungi component by mixing a mycorrhizal fungal component with a spreading or fluffing component, the mycorrhizal fungal component preferably comprising the one or more fungal species bound or adsorbed to a surface of a solid carrier and/or absorbed below the surface of the solid carrier, wherein the solid carrier is preferably selected from the group consisting of diatomaceous earth, clay, one or more phyllosilicates, and one or more naturally-occurring earth components, and wherein the spreading or fluffing component is preferably selected from the group consisting of corn starch, plant starch, plant fiber, diatomaceous earth, one or more phyllosilicates, one or more naturally-occurring earth components, and combination(s) thereof.

In some embodiments, the method further comprises one or more steps selected from the group consisting of: cultivating a microbial fermentation culture, the microbial fermentation culture comprising the fermentation medium, microorganisms, and the fermentation metabolites; and lysing at least some of the microorganisms in the microbial fermentation culture to produce the microbial fermentation product or whole culture lysate.

In some embodiments, the method further comprises one or more steps selected from the group consisting of: maintaining the solid carrier component with the microbial fermentation product applied thereto at a temperature above about 15° C. and below about 60° C. for a first period of time; and maintaining the solid carrier component with the microbial fermentation product applied thereto at a pH between about 2-10.

In some embodiments, the method further comprises one or more steps selected from the group consisting of: mixing the solid carrier component while applying the microbial fermentation product thereto; and applying a flow of air to the solid carrier component: (i) while applying the microbial fermentation product thereto and/or after applying the microbial fermentation product thereto, and/or (ii) over a period of time between about 12-120 hours and/or until the combination product (i.e., the microbial fermentation product bound to or adsorbed to a surface of the solid carrier, or absorbed below the surface of the solid carrier) has a moisture content less than or equal to about 20% (etc.), by weight.

In various aspects or embodiments of the present disclose, the composition(s) and method(s) are useful for (i) enhancing the growth of plant shoot and/or root, as compared to when mycorrhizae or biostimulant(s) are applied alone, (ii) enhancing the uptake of nutrients, as compared to when mycorrhizae or biostimulant(s) are applied alone, and/or (iii) producing synergistic effects between mycorrhizae and biostimulant(s).

Some embodiments may include any of the features, options, and/or possibilities set out elsewhere in the present disclosure, including in other aspects or embodiments of the present disclosure. It is also noted that each of the foregoing, following, and/or other features described herein represent a distinct embodiment of the present disclosure. Moreover, combinations of any two or more of such features represent distinct embodiments of the present disclosure. Such features or embodiments can also be combined in any suitable combination and/or order without departing from the scope of this disclosure. Thus, each of the features described herein can be combinable with any one or more other features described herein in any suitable combination and/or order. Accordingly, the present disclosure is not limited to the specific combinations of exemplary embodiments described in detail herein.

Additional features and advantages of exemplary embodiments of the present disclosure will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above-recited and other advantages and features of the present disclosure can be obtained, a more particular description of the embodiments briefly described above will be rendered by reference to specific embodiments thereof which are illustrated in the appended drawings. For better understanding, the like elements have been designated by like reference numbers throughout the figure(s). Understanding that these drawings depict only typical embodiments of the invention and are not therefore to be considered to be limiting of its scope, the invention will be described and explained with additional specificity and detail through the use of the accompanying drawing(s) in which:

FIG. 1A is a photograph of five (5) replicates of untreated control corn plantlets at 7 days growth in perlite.

FIG. 1B is a photograph of five (5) replicates of corn plantlets at 7 days growth in perlite after treatment with biostimulant alone.

FIG. 1C is a photograph of five (5) replicates of corn plantlets at 7 days growth in perlite after treatment with component Mycorrhiza-1 alone.

FIG. 1D is a photograph of five (5) replicates of corn plantlets at 7 days growth in perlite after treatment with biostimulant and component Mycorrhiza-1.

FIG. 1E is a photograph of five (5) replicates of corn plantlets at 7 days growth in perlite after treatment with component Mycorrhiza-2 alone.

FIG. 1F is a photograph of five (5) replicates of corn plantlets at 7 days growth in perlite after treatment with biostimulant and component Mycorrhiza-2.

FIG. 1G is a photograph of five (5) replicates of corn plantlets at 7 days growth in perlite after treatment with component Mycorrhiza-3 alone.

FIG. 2A is a photograph of the five (5) replicates of untreated control corn plantlets from FIG. 1A, harvested at 28 days.

FIG. 2B is a photograph of the five (5) replicates of corn plantlets treated with biostimulant alone, from FIG. 1B, harvested at 28 days.

FIG. 2C is a photograph of the five (5) replicates of corn plantlets treated with component Mycorrhiza-1 alone, from FIG. 1C, harvested at 28 days.

FIG. 2D is a photograph of the five (5) replicates of corn plantlets treated with biostimulant and component Mycorrhiza-1, from FIG. 1D, harvested at 28 days.

FIG. 2E is a photograph of the five (5) replicates of corn plantlets treated with component Mycorrhiza-2 alone, from FIG. 1E, harvested at 28 days.

FIG. 2F is a photograph of the five (5) replicates of corn plantlets treated with biostimulant and component Mycorrhiza-2, from FIG. 1F, harvested at 28 days.

FIG. 2G is a photograph of the five (5) replicates of corn plantlets treated with component Mycorrhiza-3 alone, from FIG. 1G, harvested at 28 days.

### DETAILED DESCRIPTION

Before describing various embodiments of the present disclosure in detail, it is to be understood that this disclosure is not limited to the specific features of the particularly exemplified systems, methods, and/or products described herein that may vary from one embodiment to the next. Indeed, those of ordinary skill in the art will understand various equivalents and details that are contemplated, though not explicitly articulated within the present disclosure. Thus, while certain embodiments of the present disclosure will be described in detail, with reference to specific features (e.g., components, ingredients, parts, portions, elements, members, combinations, configurations, parameters, properties, steps, etc.), the descriptions are illustrative and are not to be construed as limiting the scope of the present disclosure and/or the claimed invention. It is also to be understood that much, if not all of the terminology used herein is only for the purpose of describing particular embodiments of the present disclosure, and is not necessarily intended to limit the scope of the disclosure in any particular manner.

Unless defined otherwise, all technical and scientific terms used herein have the same meaning as commonly understood by one of ordinary skill in the art to which the present disclosure pertains.

Various aspects of the present disclosure, including systems, methods, and/or products may be illustrated with reference to one or more embodiments or implementations, which are exemplary in nature. As used herein, the terms “embodiment” and “implementation” mean “serving as an example, instance, or illustration,” and should not necessarily be construed as preferred or advantageous over other aspects disclosed herein. In addition, reference to an “implementation” of the present disclosure or invention includes a specific reference to one or more embodiments thereof, and vice versa, and is intended to provide illustrative examples without limiting the scope of the invention, which is indicated by the appended claims rather than by the description thereof.

As used throughout this disclosure, the words “can” and “may” are used in a permissive sense (i.e., meaning having the potential to), rather than the mandatory sense (i.e., meaning must). Additionally, the terms “including,” “having,” “involving,” “containing,” “characterized by,” variants thereof (e.g., “includes,” “has,” and “involves,” “contains,” etc.), and similar terms as used herein, including the claims, shall be inclusive and/or open-ended, shall have the same meaning as the word “comprising” and variants thereof (e.g., “comprise” and “comprises”), and do not exclude additional, un-recited elements or method steps, illustratively.

As used in this specification and the appended claims, the singular forms “a,” “an” and “the” each contemplate, include, and specifically disclose both the singular and plural referents, unless the context clearly dictates otherwise. For example, reference to a “carrier” contemplates and specifically discloses one, as well as two or more nucleic acids. Similarly, use of a plural referent does not necessarily require a plurality of such referents, but contemplates, includes, and specifically discloses one, as well as two or more of such referents, unless the context clearly dictates otherwise.

It will also be appreciated that where two or more values, or a range of values (e.g., less than, greater than, at least, and/or up to a certain value, and/or between two recited values) is disclosed or recited, any specific value or range of values falling within the disclosed values or range of values is likewise specifically disclosed and contemplated herein. Thus, disclosure of an illustrative measurement (e.g., length, width, thickness, etc.) that is less than or equal to about 10 units or between 0 and 10 units includes, illustratively, a specific disclosure of: (i) a measurement of 9 units, 5 units, 1 units, or any other value between 0 and 10 units, including 0 units and/or 10 units; and/or (ii) a measurement between 9 units and 1 units, between 8 units and 2 units, between 6 units and 4 units, and/or any other range of values between 0 and 10 units.

Various aspects or embodiments of the present disclosure can be illustrated by describing components that are bound, coupled, attached, connected, and/or joined together. As used herein, the terms “bound,” “coupled”, “attached”, “connected,” and/or “joined” are used to indicate either a direct association between two components or, where appropriate, an indirect association with one another through intervening or intermediate components. In contrast, when a component is referred to as being “directly bound,” “directly coupled”, “directly attached”, “directly connected,” and/or “directly joined” to another component, no intervening elements are present or contemplated. Furthermore, binding, coupling, attaching, connecting, and/or joining can comprise mechanical, physical, and/or chemical association.

In addition, various aspects or embodiments of the present disclosure can be illustrated by describing components that are mixed together. As used herein, “mixed,” “mixing,” and similar terms indicate a physical combining or combination of two or more components. In some embodiments, the physical combining or combination results in a (chemical and/or physical) reaction. Such chemical reactions can be evidenced by a change in the chemical composition, pH, or other indicator relative to the components prior to being mixed (or as expected after being mixed absent the reaction). Thus, mixing and/or mixed components can include reacting and/or reacted components in certain embodiments. Accordingly, reference to mixing or mixed components includes a reference to reacting or reacted components.

To facilitate understanding, like reference numerals have been used, where possible, to designate like elements common to the figures. Specifically, in the exemplary embodiments illustrated in the figures, like structures will be provided with similar reference designations, where possible. Specific language will be used herein to describe the exemplary embodiments. Nevertheless, it will be understood that no limitation of the scope of the disclosure is thereby intended. Rather, it is to be understood that the language used to describe the exemplary embodiments is illustrative only and is not to be construed as limiting the scope of the disclosure (unless such language is expressly described herein as essential).

While the detailed description is separated into sections, the section headers and contents within each section are for organizational purposes only and are not intended to be self-contained descriptions and embodiments or to limit the scope of the description or the claims. Rather, the contents of each section within the detailed description are intended to be read and understood as a collective whole, where elements of one section may pertain to and/or inform other sections. Accordingly, embodiments specifically disclosed within one section may also relate to and/or serve as additional and/or alternative embodiments in another section having the same and/or similar products, methods, and/or terminology.

Embodiments of the present disclosure include novel compositions containing mycorrhizal fungi and biostimulant(s), and methods of manufacturing and using the same. In particular, embodiments of the present disclosure include synergistic combinatorial products comprising mycorrhizal fungi and biostimulant(s), and specifically, synergistic combinations of mycorrhizal fungi with biostimulant(s) and optional nutrients, which can be useful for improving plant growth and/or plant yield when applied to soil or seed, or seedling or plant. Illustrative embodiments of the present disclosure can include a combinatorial product (mixture) that can be applied to plants (or plantlets), seed, or soil, or a system (kit) comprising a plurality of products that can be co-applied to soil or seed, or seedling or plant. The combinatorial product or system can comprise a mycorrhizal fungi component (or product) and a biostimulant(s) component (or product). The components of the combinatorial product or system can each be in solid form (e.g., granular, powdered, particulate, or combinations thereof) or liquid form (e.g., solution, suspension, emulsion, colloid, or combinations thereof). In at least one aspect or embodiment of the present disclosure, the mycorrhizal fungi component (or product) comprises one or more fungal species. Non-limiting examples of fungal species include: Glomus sp., Gigaspora sp., Scutellospora sp., Acaulospora sp., Entrophospora sp., Rhizophagus sp., and Claroldeoglomus sp. fungi. In some embodiments, the mycorrhizal fungi component (or product) can include one or more species of Rhizophagus, more preferably Rhizophagus irregularis, Rhizophagus aggregatus, and/or Rhizophagus clarus. In some embodiments, the mycorrhizal fungi component (or product) can include one or more species of Claroideoglomus, preferably Claroideoglomus etunicatum. In some embodiments, the mycorrhizal fungi component (or product) can include one or more species of Glomus, preferably Glomus intraradices and/or Glomus mosseae. In some embodiments, the mycorrhizal fungi component (or product) can include two or more species of fungi.

In at least one aspect or embodiment of the present disclosure, the biostimulant component (or product) disclosed herein comprise at least one biostimulant. Non-limiting examples of biostimulant(s) include: microbial (e.g., bacterial) fermentation (whole culture lysate) products, humic acid(s), fulvic acid, seaweed extract(s), protein hydrolysate(s), chitosan(s), pyroglutamic acid, etc., and various combination(s) thereof. In some embodiments, the composition, kit, or system can one or more beneficial microorganisms, such as Rhizobia sp. and/or Azospirillum sp.

Illustrative embodiments include a composition, comprising: a mycorrhizal fungi component comprising one or more fungal species; and a biostimulant component comprising: lysed microorganisms; fermentation medium; and fermentation metabolites. Illustrative compositions can include a mycorrhizal fungi component comprising one or more fungal species; and a biostimulant component comprising a solid carrier component and a microbial fermentation product adsorbed to a surface of the solid carrier component and/or absorbed below the surface of the solid carrier component, the microbial fermentation product comprising: lysed microorganisms; fermentation medium; and fermentation metabolites.

Illustrative compositions can include a mycorrhizal fungi component comprising one or more fungal species bound or adsorbed to a surface of a solid carrier and/or absorbed below the surface of the solid carrier; and a biostimulant component comprising a solid carrier component and a microbial fermentation product adsorbed to a surface of the solid carrier component and/or absorbed below the surface of the solid carrier component, the microbial fermentation product comprising: lysed microorganisms; fermentation medium; and fermentation metabolites.

Illustrative compositions can include (i) a mycorrhizal fungi component comprising one or more fungal species bound or adsorbed to a surface of a solid carrier and/or absorbed below the surface of the solid carrier, wherein the solid carrier is selected from the group consisting of diatomaceous earth, clay, one or more phyllosilicates, and one or more naturally-occurring earth components, and wherein the one or more fungal species is selected from the group consisting of Glomus sp., Gigaspora sp., Scutellospora sp., Acaulospora sp., Entrophospora sp., Rhizophagus sp., and Claroldeoglomus sp., and optionally further comprises one or more spreading agents, preferably selected from the group consisting of corn starch, plant starch, plant fiber, diatomaceous earth, one or more phyllosilicates, and one or more naturally-occurring earth components; and (ii) a biostimulant component comprising a solid carrier component and a microbial fermentation product adsorbed to a surface of the solid carrier component and/or absorbed below the surface of the solid carrier component, the microbial fermentation product comprising a whole culture lysate, comprising: lysed microorganisms; fermentation medium; and fermentation metabolites, wherein less than about 50%, by weight, of biomass in the microbial fermentation product is living or viable microorganisms, and wherein the solid carrier component is selected from the group consisting of one or more phyllosilicates, one or more naturally-occurring earth components, talc, bentonite, humic acid(s), plant material(s), plant extract(s), and combination(s) thereof; and at least one additional component selected from the group consisting of: one or more minerals or nutrients, preferably selected from the group consisting of zinc, zinc sulfate, zinc oxide, magnesium, magnesium oxide, calcium, and calcium oxide, wherein the composition has a moisture content less than or equal to about 20%, by weight, preferably less than or equal to about 15%, by weight, more preferably less than or equal to about 10%, by weight, still more preferably less than or equal to about 8%, by weight, still more preferably less than or equal to about 5%, by weight, still more preferably less than or equal to about 3%, by weight.

At least one aspect or embodiment of the present disclosure can include a method, comprising applying the composition (as described herein) to soil or to a seed, seedling, or plant.

At least one aspect or embodiment of the present disclosure can include a method of manufacturing a composition, the method comprising combining a mycorrhizal fungi component comprising one or more fungal species with a biostimulant component comprising: lysed microorganisms; fermentation medium; and fermentation metabolites.

Illustrative methods of manufacturing a composition can include: forming a biostimulant component by applying a microbial fermentation product in liquid form to a solid carrier component such that the fermentation product is adsorbed to the surface of the solid carrier and/or absorbed below the surface of the solid carrier; and mixing the biostimulant component with a mycorrhizal fungi component comprising one or more fungal species.

Illustrative methods of manufacturing a composition can include: forming a biostimulant component by: (i) obtaining a solid carrier component, the solid carrier component preferably comprising a dry, powdered, and/or granular composition comprising one or more phyllosilicates, diatomaceous earth, one or more naturally-occurring earth components, humic acid(s) or potassium humate, and/or fulvic acid; (ii) (forming a biostimulant component by applying a microbial fermentation product in liquid form to the solid carrier component such that the fermentation product is adsorbed to the surface of the solid carrier and/or absorbed below the surface of the solid carrier, the microbial fermentation product preferably comprising a whole culture lysate, comprising: lysed microorganisms; fermentation medium; and fermentation metabolites; allowing the solid carrier component with microbial fermentation product applied thereto to dry to a moisture content below about 20% (etc.), by weight; and optionally mixing the solid carrier component with microbial fermentation product applied thereto and having a moisture content below about 20% (etc.), by weight, with one or more nutrients, in dry, solid, powdered, and/or granular form, preferably having a moisture content below about 20% (etc.), by weight, the one or more nutrients preferably selected from the group consisting of zinc, zinc sulfate, zinc oxide, magnesium, magnesium oxide, calcium, and calcium oxide; and (iii) combining the biostimulant component with a mycorrhizal fungi component in dry, solid, powdered, and/or granular form, the mycorrhizal fungi component preferably having a moisture content below about 10%, by weight, the mycorrhizal fungi component comprising one or more fungal species, preferably selected from the group consisting of Glomus sp., Gigaspora sp., Scutellospora sp., Acaulospora sp., Entrophospora sp., Rhizophagus sp., and Claroldeoglomus sp.

Some of the foregoing and other aspects and/or embodiments of the present disclosure, including specific components, characteristics, features, and/or steps thereof, will now be discussed in further detail.

### Exemplary Carriers and Carrier Components

As used herein, “carrier”, “carrier component”, and similar terms refer to a component adapted for conveying a substance. For instance, the carrier component can comprise a solid, dry, and/or substantially dry carrier, or in a substantially dry and/or solid form, such as powdered and/or granular form.

The composition can have a moisture content between about 2%, 1%, 0.5%, 0.25%, 0.1%, or 0.01% and about 20%, 15%, 10%, 8%, 6%, or 5%, by weight. In some embodiments, the carrier can have a moisture content of less than about 20% by weight, less than about 15% by weight, less than about 10% by weight, less than about 5% by weight, less than about 3% by weight, less than about 2% by weight, or less than about 1% by weight. In at least one embodiment, the carrier can have a moisture content between about 1%, 0.5%, 0.25%, 0.1%, or 0.01% and about 1%, 2%, 3%, 4%, 5%, 6%, 7%, 8%, 9%, 10%, 12%, 15%, 18%, or 20% by weight, between about 0.5% and about 1%, 2%, 3%, 4%, 5%, 10%, 15%, or 20% by weight. As used herein, the term “substantially dry carrier” refers to a carrier having one or more of the foregoing moisture contents. Such substantially dry carriers can be understood generally to be solid, dry substances, while still having at least some moisture associated therewith.

In at least one embodiment, the carrier can comprise an organic and/or earthen carrier, comprising one or more organic and/or earth components or materials. Earthen carriers, components, and/or materials can include, for example, phyllosilicate(s) (e.g., of potassium (K), sodium (Na), calcium (Ca), and/or aluminum (Al)). The phyllosilicate can be of the chlorite, clay, mica, or serpentine variety. In at least one embodiment, the carrier can comprise one or more 1:1 or 2:1 clay mineral phyllosilicates. Carriers can also comprise organic matter or material(s). For example, carriers can comprise humic acid(s) or potassium humate, fulvic acid, combination(s) thereof, etc. Carriers can also or alternatively comprise diatomite and/or other diatomaceous earth, or other matter obtained from living organism(s). Carriers can also include (dried) plant materials and/or extracts, e.g., meal, flour, protein powders, seaweed, and so forth.

Exemplary carriers can comprise, without limitation, aliettite, attapulgite, beidellite, bentonite, biotite, calcium silicate, calcium stearate, chlorite (e.g., clinochlore, chamosite, nimite, pennantite, and/or zinc, lithium, and/or calcium species thereof), cookeite, diatomite and/or other diatomaceous earth products, dickite, glauconite, halloysite, hectorite, hydrophobic silica, illite, kaolin, kaolinite, montmorillonite, muscovite, nacrite, nontronite, palygorskite, phyllite, saponite, sauconite, sepiolite, sericite, serpentine, smectite, talc, tonstein, vermiculite, humic acid(s) or potassium humate, fulvic acid, and so forth. Certain carriers can be or comprise a naturally-occurring and/or earth material or component. Other carriers can be or comprise an artificial and/or synthesized material or component.

Illustratively, carriers or carrier component(s) preferred for biostimulant components or compositions (or microbial fermentation (whole culture lysate) product), such as carrier component(s) for delivering or conveying microbial fermentation product(s), e.g., by adsorbing and/or absorbing liquid microbial fermentation (whole culture lysate) products, can include one or more phyllosilicate, such as 1:1 or 2:1 clay mineral phyllosilicates (e.g., bentonite and/or talc), organic material(s), humic acid(s) or potassium humate, fulvic acid, diatomite(s) and/or other diatomaceous earth product(s), and various combination(s) thereof. In an exemplary embodiment, the carrier for the biostimulant components or compositions (or microbial fermentation (whole culture lysate) product) can include humic acid(s) or potassium humate and/or fulvic acid (e.g., BorreGro® HA-2).

Illustratively, carriers or carrier component(s) preferred for mycorrhizal fungi components (including one or more fungal species), such as carrier(s) for delivering or conveying the one or more fungal species, e.g., by binding, adsorbing and/or absorbing (liquid) fungal culture(s), can include one or more organic material(s), diatomite(s) and/or other diatomaceous earth product(s), one or more phyllosilicate, such as 1:1 or 2:1 clay mineral phyllosilicates (e.g., bentonite and/or talc), and various combination(s) thereof.

In some embodiments, the carrier can be in powdered, granular, and/or particulate form or have an average particle size between about 20-297 μm (e.g., corresponding to approximately 625-50 mesh). In at least one preferred embodiment, the carrier can have an average particle size of about 74 μm (or about 200 mesh)+/−20%, 15%, 10%, 8%, or 5%. In certain embodiments, the solid carrier can be sized (e.g., by milling, crushing, grinding, etc.) to a suitable average particle size. Accordingly, in some embodiments, the solid carrier can be a mined and milled earth component having a suitable average particle size.

The carrier component can also or alternatively comprise a liquid or liquid composition (e.g., solution, suspension, colloid, mixture, etc.). In such embodiments, the composition, carrier, and/or fermentation product can be in a fluid and/or liquid form (e.g., a solution, colloid, suspension, or other fluid and/or liquid mixture). Exemplary liquid carriers include, without limitation, water, a water source, a water supply, a liquid fertilizer, liquid pesticide, or any suitable liquid composition or carrier, such as a solvent (of a solution), a continuous phase (of a colloid), an external phase (of a suspension), etc.

Thus, the carrier can comprise any suitable material adapted for or capable of conveying a substance. In addition, the carrier can be easily applied to soil or seed, seedling or plant.

### Exemplary Biostimulant(s)

Illustrative examples of biostimulant(s) include humic acid(s), potassium humate, fulvic acid, seaweed extract(s), protein hydrolysate(s), chitosan(s), pyroglutamic acid, microbial (e.g., bacterial) fermentation products (e.g., whole culture lysate of microbial fermentation culture), and various combination(s) thereof.

An illustrative example of a biostimulant(s) product comprises humic acid(s) or potassium humate and/or fulvic acid (e.g., BorreGro® HA-2).

### Exemplary Fermentation Products

As used herein, a (microbial, bacterial, yeast, fungal, etc.) “fermentation product” or similar term refers to a resultant of at least a period of anaerobic metabolism or cellular respiration (e.g., by one or more microorganisms), as understood by those skilled in the art, and not merely bulk or other growth (e.g., of such microorganism(s) on or in a growth medium). In some embodiment, the fermentation product can also result from (one or more periods of) aerobic metabolism. The fermentation product preferably comprises one or more anaerobic metabolite products or metabolites. The metabolites or metabolite products preferably having been produced by said one or more microorganisms. The fermentation product preferably comprising cellular material of the one or more microorganisms. The cellular material can comprise cellular components of lysed microorganisms. The cellular material can comprise cellular structural components of or produced by the one or more microorganisms. The cellular structural components can include cell wall, or fragments thereof, of or produced by the one or more microorganisms. The cellular structural components can include organelle or fragments thereof, of or produced by the one or more microorganisms. The cellular material can comprise genetic material of or produced by the one or more microorganisms. The cellular material can comprise macromolecules of or produced by the one or more microorganisms.

The fermentation product can comprise a condensed and/or extracted fermentation product, a presscake, fermentation solubles, a fermentation extract, dried fermentation solubles, liquid fermentation product, dried fermentation biomass, or a combination thereof. As used herein, a “liquid fermentation product” or similar term refers to a fermentation product in liquid form. For instance, the liquid fermentation product can be or comprise components of a liquid fermentation culture (e.g., a whole or complete microbial fermentation suspension culture), including a (at least partially spent or post-fermentation) liquid culture medium or component(s) thereof, one or more microorganisms and/or cellular material (e.g., structural components) thereof, one or more (fermentation, anaerobic, aerobic, and/or other) metabolites (produced by the microorganisms, and other components as known in the art.

The microbial fermentation product can be processed (e.g., purified, filtered, isolated, separated, etc.) or crude (e.g., unprocessed). In some embodiments, the fermentation product can comprise the substantially unpurified resultant of microbial anaerobic (and optionally aerobic) metabolism, including one or more (fermentation) metabolites, a (liquid) fermentation medium (e.g., remaining after a fermentation process), and/or microbial cellular and/or structural components (e.g., whole cell lysate).

In at least one embodiment, the fermentation product includes one or more (lysed) microorganisms and/or cellular material, such as cellular structural components, including cell wall or fragments thereof, organelle or fragments thereof, and so forth, genetic material, macromolecules, or other component thereof. As used herein, the terms “microorganism,” “microbial organism,” “microbe,” and the like refer to a species or strain of bacteria, archaea, certain protozoa, fungi, such as yeast, mold, etc., and algae, whether single-celled or multi-cellular organism, whether prokaryotic or eukaryotic, as understood by those skilled in the art. In some embodiments, the fermentation product includes (whole-cell) lysed microorganisms. The one or more microorganisms may include any number of microorganism species or strains, including, without limitation, one, two, three, four, five, six, seven, eight, nine, ten, or any other number of discrete (e.g., separately identifiable) microorganism strains or species.

Exemplary bacteria can include, without limitation: a species or strain of lactic acid bacteria, a species or strain of Acetobacter, including species aceti, xylinum, suboxydans, and so forth; a species or strain of Bacillus, including species apiaries, azotofixans, brevis, cereus, circulans, coagulans, laterosporus, lentus, licheniformis, macerans, marinus, megaterium, pasteurii, polymyxa, pulvifaciens, pumilus, schlegelii, sphaericus, stearothermophilus, subtilis, thiaminolyticus, thuringiensis, tusciae, and so forth; a species or strain of Bacteroides, including species amylophilus, copillosus, ruminocola, suis, and so forth; a species or strain of Bifidobacterium, including species adolescentis, animalis, bifidum, infantis, longum, thermophilum, and so forth; a species or strain of Enterococcus, including species cremoris, diacetylactis, faecium, intermedius, lactis, thermophilus, and so forth; a species or strain of Lactobacillus, including species acidophilus, brevis, buchneri, bulgaricus, casei, cellobiosus, curvatus, delbruekii, farciminis, fermentum, helveticus, lactis, plantarum, reuteri, and so forth; a species or strain of Leuconostoc, including species citovorum, dextranicum, mesenteroides, and so forth; a species or strain of Megasphaera, including species elsdenii, and so forth; a species or strain of Pediococcus, including species acidilactici, cerevisiae (damnosus), pentosaceus, and so forth; a species or strain of Propionibacterium, including species freudenreichii, shermanii, and so forth; a species or strain of Rhodopseudomonas, including species palustris, and so forth; and/or a species or strain of Streptococcus, including species cremoirs, diacetilactis, faecium, intermedius, lactis, salivarius, thermophilus, and so forth. Other embodiments include, for example, a species or strain of Streptomyces, including species natalensis, chattanoogensis, griseus, and so forth; a species or strain of Xanthomonas, including species campestris, and so forth; a species or strain of Rhizopus, including species niveus, and so forth; a species or strain of Micrococcus, including species lysodeikticus, and so forth; a species or strain of Bacillus, including species cereus, and so forth; and/or a species or strain of Leuconostoc, including species citovorum, dextranicum, and so forth.

Alternatively, or in addition, the cellular material can comprise cellular components of one or more yeast, fungus, and/or algae species or strains.

In at least one embodiment, the fermentation product can include Lactobacillus sp. (e.g., L. acidophilus or other species or strain) and/or cellular or structural components thereof. Optionally, embodiments can include one or more additional (lysed) microbial (e.g., bacterial, fungal, yeast, mold, algae) species or strains (such as one or more of those listed herein) and/or cellular or structural components thereof.

In some embodiments, the one or more microorganisms do not include a bacteria or bacterial species or strain or are substantially devoid of bacteria and/or cellular or structural components thereof. For instance, in some embodiments, the fermentation product can be a fungal (e.g., yeast and/or mold) fermentation product that is substantially devoid of bacteria and/or cellular or structural components thereof. Exemplary fungi can include, without limitation, yeast of phyla Ascomycota, such as Saccharomycotina and/or Taphrinomycotina (e.g., Schizosaccharomyces), and/or phyla Basidiomycota, such as Agaricomycotina (e.g., Tremellomycetes) and/or Pucciniomycotina (e.g., Microbotryomycetes). Exemplary yeast can include a species or strain of Candida (previously known as Torulopsis) including species utilis, glabrata, guilliermondii, lipolytica, pseudotropicalis, and so forth; a species or strain of Kluyveromyces including species lactis, and so forth; and/or a species or strain of Saccharomyces, including species cerevisiae, boulardii, fragilis, and so forth. Exemplary fungi can further include a species or strain of Aspergillus, including species niger, orizae (or oryzae), and so forth; a species or strain of Penicillium including specise roquefortii, and so forth; a species or strain of Mucor, including species miehei, pusillus, and so forth; a species or strain of Morteirella, including species vinaceae, and so forth; a species or strain of Endothia, including species parasitica, and so forth; and/or a species or strain of Rhizomucor, including species miehei, and so forth.

Some embodiments can be substantially devoid of fungi, yeast, mold, and/or cellular or structural components of any one or more of the foregoing. For instance, in some embodiments, the (microbial) fermentation product can be a bacterial fermentation product that is substantially devoid of fungi, yeast, mold, and/or cellular or structural components of any one or more of the foregoing. Some embodiments can be substantially devoid of mold and/or cellular or structural components thereof. For instance, in some embodiments, the fermentation product can be a bacterial and/or yeast fermentation product that is substantially devoid of mold and/or cellular or structural components thereof. Some embodiments can be substantially devoid of algae and/or cellular or structural components thereof. Certain embodiments can include at least one bacterial species or strain, at least one fungal (or yeast, or mold) species or strain, and/or at least one algae species or strain.

In some embodiments, the one or more microorganisms may be beneficial, as understood by those skilled in the art, and/or may be generally recognized as safe (GRAS—an American Food and Drug Administration (FDA) designation, which indicates that a substance added to a food is considered safe by experts, and so is exempted from the usual Federal Food, Drug, and Cosmetic Act (FFDCA) food additive tolerance requirements), as understood by those skilled in the art. Thus, in at least one embodiment, the fermentation product can be substantially devoid of harmful and/or non-GRAS microorganisms, such as E. coli, salmonella, listeria, and/or campylobacter, and/or cellular or structural components thereof. In some embodiments, the fermentation product can also be substantially devoid of certain (harmful) species or strains of Mycobacterium, Clostridium, Pseudomonas, Shigella, etc., and/or cellular or structural components thereof. Some embodiments can also or alternatively include one or more non-GRAS microbes, including without limitation one or more of the non-GRAS microbes disclosed herein.

In at least one embodiment, the one or more microorganisms of the fermentation product can be in a spore form, a vegetative form, a metabolic form, or a combination thereof. In some embodiments, however, the one or more microorganisms of the fermentation product can be non-living, non-viable, non-metabolic, and/or lysed. Accordingly, the fermentation product can comprise one or more non-living, non-viable, non-metabolic, and/or lysed microorganism, or cellular material (e.g., cell structural components) thereof. In addition, the fermentation product can be substantially devoid of one or more or any living (e.g., metabolic, dormant, sporulated, etc.) microorganisms. For instance, the fermentation product can comprise or be comprised of less than about 50%, less than about 40%, less than about 30%, less than about 25%, less than about 20%, less than about 15%, less than about 10%, less than about 5%, less than about 1%, less than about 0.5%, less than about 0.25%, less than about 0.1%, less than about 0.05%, less than about 0.01%, or less living or viable microorganisms. Accordingly, whereas probiotic products or direct-fed microorganism (DFM)-containing products may comprise live cultures, a source of live or viable, naturally occurring microorganisms, etc., some embodiments of the present disclosure can include a microbial fermentation product that is substantially or entirely devoid of live or viable microorganisms (of one or more varieties). In particular, the microorganisms can be intentionally killed and/or inactivated (e.g., by lysing, such as by sonication, vigorous mixing or blending, heat inactivation, pH inactivation, and so forth), as known in the art.

In some embodiments, less than about 50%, by weight, of biomass in the microbial fermentation product is living or viable microorganisms. In some embodiments, less than about 45%, 40%, 35%, 30%, 25%, 20%, 15%, 10%, 5%, or 1%, by weight, of biomass in the microbial fermentation product is living or viable microorganisms.

As indicated above, the fermentation product can also include a liquid (fermentation) medium (e.g., remaining after a fermentation process). Accordingly, the fermentation product can comprise a resultant of microbial liquid suspension culture grown in anaerobic (and optionally acrobic) conditions. The medium can include a liquid base component, such as water or a nutrient broth (e.g., Lysogeny Broth (LB), M9, fluid thioglycollate medium (FTM), NZ, NZY, or NZYM broths, SOB, SuperBroth, 2X YT, MOPS, SOC, TB, and so forth). The medium can also include one or more nutrient, growth, and/or other components (e.g., remaining after the fermentation process), such as (i) a carbon source (e.g., carbohydrate, such as glucose, sucrose, fructose, lactose, galactose, etc.), (ii) (inorganic) nitrogen source (e.g., ammonium, urea, etc.), (iii) protein or amino acid source (e.g., synthetic proteins or amino acids, natural, plant- and/or animal-derived proteins or amino acids, such as whey, milk, or milk-based product, etc.), (iv) vitamin (e.g., thiamine (Vitamin B1), riboflavin (Vitamin B2), niacin (Vitamin B3), choline (Vitamin B4), pantothenic acid (Vitamin B5), pyridoxal (Vitamin B6), biotin (Vitamin B7), inositol (e.g., myo-inositol, Vitamin B8, etc.), folic acid (Vitamin B9), benzoic acid (e.g., para amino benzoic acid (PABA), Vitamin B10, etc.), salicylic acid (Vitamin B11), cobalamin (Vitamin B12), Vitamin E, Vitamin D, Vitamin K, Vitamin A, Vitamin C, Vitamin H, etc.) or coenzyme thereof (e.g., ascorbate, retinol, etc.), (v) mineral (e.g., sodium, potassium, calcium, magnesium, etc.), (vi) trace element (e.g. copper, iron, manganese, zinc, molybdenum, chromium, selenium, etc.), (vii) essential element (e.g., magnesium, nitrogen, phosphorus, sulfur), (viii) salt(s) thereof (e.g., molybdate, cellulite, sulfate, chloride, propionate, etc.), (ix) salt (e.g., potassium phosphate, sodium phosphate, sodium chloride, ammonium chloride, magnesium sulfate, calcium chloride, etc.), (x) plant, including a component, part, or extract thereof (e.g., seaweed, such as kelp (e.g., brown algae (Phaeophyceae), such as Ascophyllum nodosum, optionally in meal form (e.g., dried and ground), (xi) yeast or extract thereof, (xii) enzyme, and/or (xiii) any other suitable (fermentation) culture component, as known to those skilled in the art. In addition, certain fermentation products can specifically exclude one or more of the foregoing or other known culture components (e.g., serum, growth factor, hormone, enzyme, antibiotic, beef extract, whole blood, heat-treated blood, etc.). It will be appreciated that one or more components found in the medium can be added to the medium before, during, and/or after one or more growth phases of the culture. Alternatively, or in addition, it will be appreciated that one or more components found in the medium can be produced by the microbes growing in the fermentation culture (e.g., as (fermentation) metabolites).

The fermentation product can include one or more metabolites. In at least one embodiment, the one or more metabolites comprise fermentation or other metabolites produced by the microorganisms (e.g., during anaerobic and optionally aerobic metabolism). Microbial fermentation metabolites can include, without limitation, one or more organic acids (e.g., lactic acid, humic acid, carboxylic acid (e.g., carbonic acid, acetic acid, formic acid, propionic acid, butyric acid, valeric acid, caproic acid, etc.), citric acid, salicylic acid, ascorbic acid, and so forth) amino acids, carbohydrates, fats, fatty-acids, enzymes, vitamins, and/or any other microbial metabolite component, as known to those skilled in the art. The metabolite(s) can be nutritionally beneficial to one or more seeds, roots, stems, shoots, plantlets, or plants. In some embodiments, the fermentation product can include one or more microorganism waste products. In some embodiments, the metabolite(s) can be or comprise one or more microorganism waste products. In at least one embodiment, the fermentation product can be substantially devoid of antimicrobials (e.g., bacteriocins, antibiotics, hydrogen peroxide, and so forth); certain enzymes (e.g., proteases, amylases, lipases, glycosidases, DNA and/or RNA polymerases), and so forth.

In some embodiments, the metabolites can be at least partially purified (e.g., away from undesirable matter, such as waste products, fermentation medium, microbial cellular and/or structural material, etc.). Alternatively, the metabolites can be substantially unpurified in one or more embodiments. The substantially unpurified metabolites can be disposed in the microbial organisms and/or the (liquid) fermentation medium (e.g., outside of the microbial organisms). In some embodiments, the microorganisms can be lysed (e.g., such that substantially all of the metabolites are free in solution (i.e., not contained within the microorganisms)). Accordingly, in some embodiments, the fermentation product can comprise a mixture (e.g., solution, colloid, suspension, colloidal suspension, emulsion, etc.) of post-fermentation liquid medium, one or more microbial fermentation metabolites (e.g., anaerobic and/or aerobic metabolic products), and microbial cellular and/or structural components (e.g., whole cell lysate). In at least one embodiment, the mixture can be crude, raw, and/or substantially unpurified.

Exemplary fermentation methods, parameters, etc. include those known to those skilled in the art. The fermentation product can be prepared by one or more fermentation processes, including growing of one or more microbial (e.g., bacterial) species or strains or cell lines on a solid growth medium, as known in the art. The microbial culture can be grown in natural and/or ambient conditions in some embodiments. In other embodiments, the culture can be grown in artificial and/or optimized conditions. The microbial cultures can be grown at a biologically-suitable temperature (e.g., between about 20-50 degrees Celsius (° C.) or between about 30-40° C.), acidity (pH) (e.g., about 3.0-8.0), etc. Moreover, the growth medium can include one or more of the above-described or other medium components, including, without limitation, a (substantially solid) base component (e.g., agar or other suitable base component), nutrient, growth, and/or other components (e.g., carbon and/or (inorganic) nitrogen source, vitamin, mineral, trace element, essential element, amino acid, amino acid source, salt, yeast extract, and/or any other culture component, as known to those skilled in the art. In at least one embodiment, the microbial culture can be grown in aerobic and/or anaerobic conditions.

In some embodiments, the fermentation process can also include inoculating one or more (of the) viable microorganisms or microbial lines (or colonies thereof) into a liquid growth medium (e.g., to form a starter suspension culture), as known in the art. Liquid (suspension) cultures can also be grown in natural and/or ambient or artificial and/or optimized conditions, as described above. The liquid growth medium can include one or more of the above-described or other medium components.

In at least one embodiment, the viable starter culture (or a suitable portion thereof, including a whole fraction, extract, cell pellet, etc. thereof) can be transferred into liquid fermentation medium (e.g., to form a liquid fermentation culture). The liquid fermentation medium and/or culture can be disposed in a bioreactor, flask, or other suitable growth container. Moreover, the liquid fermentation medium and/or culture can include one or more of the above-described or other medium components. Similarly, the liquid fermentation culture can also be grown in natural and/or ambient or artificial and/or optimized conditions, as described above. In at least one alternative embodiment, the one or more viable microorganisms or microbial lines (or colonies thereof) can be inoculated directly into a liquid fermentation medium.

The fermentation culture can be grown under anaerobic and/or aerobic conditions for a first period of time and/or under first fermentation conditions, as known in the art and described herein. For instance, the fermentation culture can be grown for between about 0.5 days and about 5 days, at a temperature between about 10-50° C., and/or at a pH between about 2-10. After the first period of time, the fermentation culture can be grown under anaerobic and/or aerobic conditions for a second period of time and/or under second fermentation conditions, as known in the art and described herein. For instance, the second period of time can be between 0.5 days and about 5 days. The second fermentation conditions can include a temperature between about 10-50° C., a pH between about 2 and about 10, etc. In some embodiments, the second period of time and/or second fermentation conditions can be different than the first period of time and/or first fermentation conditions. For instance, the fermentation culture (or suitable portion thereof) can be transferred into the second fermentation conditions and/or a second fermentation medium. The second fermentation medium can be disposed in a bioreactor, flask, or other suitable growth container and/or can include one or more of the above-described or other medium components.

It will be appreciated that the fermentation process can also include additional period(s) of time, fermentation condition(s), fermentation media, etc., as known in the art and described herein. At the completion of the fermentation process, the fermentation culture can be or comprise a microbial fermentation product and/or can be optionally and/or additionally processed to form a microbial fermentation product. For instance, in certain embodiments, the (anaerobically and/or aerobically metabolic) microorganisms of the fermentation culture can be intentionally killed and/or inactivated (e.g., by lysing, such as by sonication, vigorous mixing, or blending, heat inactivation, pH inactivation or killing, and so forth), as known in the art. In at least some embodiments, fermentation metabolites disposed within the microbial cells or organisms of the fermentation culture can thereby be released into the medium (e.g., such that the metabolites are free in solution or other liquid medium type). The non-living, non-viable, non-metabolic, and/or lysed microorganism, or cellular material (cell structural components) thereof, can be retained in the liquid fermentation medium or at least partially (e.g., substantially and/or completely) removed therefrom (e.g., via (ultra) centrifugation, filtration, etc.). In certain embodiments, the fermentation product comprises a whole-cell and/or whole-culture lysate of the fermentation culture (e.g., without substantial removal, purification, isolation, etc. of one or more (e.g., any) component(s) of the fermentation culture). In alternative embodiments, however, one or more components of the fermentation culture can be at least partially and/or substantially removed, purified, isolated, etc.

Accordingly, the fermentation product can be in a substantially liquid (suspension, solution, colloid, gel, slurry, etc.) form and/or can include one or more components of a microbial fermentation culture (e.g., prepared as described herein and/or as known in the art). In at least one exemplary embodiment, the fermentation product can comprise a liquid suspension comprising the substantially unpurified resultant of microbial anaerobic and optionally aerobic metabolism, including (i) substantially all of the (fermentation) metabolites produced by the fermentation culture, (ii) the liquid fermentation medium in which the fermentation culture was grown (e.g., remaining after a fermentation process), and (iii) a whole-cell lysate the microorganisms or culture, including all of the microbial cellular and/or structural components of the microorganisms grown in the fermentation culture. Alternatively, the fermentation product can be in substantially solid form (e.g., dried, freeze-dried, vacuum-dried, heat-dried, dehydrated, extracted, etc.), comprising one or more of the foregoing components of the fermentation culture.

Embodiments can comprise one or more additional components. Embodiments can comprise a mixture of additional components. The one or more additional components can comprise (residual) supplement components. The one or more additional components can be selected, independently, from the group consisting of one or more vitamins, minerals, trace minerals, amino acids, health supplements, pharmaceuticals, plant extracts (e.g., seaweed extracts), phytonutrients, carotenoids, enzymes, probiotics, lignosulfonates, and organic acids (e.g., humic acids), one or more minerals or nutrients, preferably selected from the group consisting of zinc, zinc sulfate, zinc oxide, magnesium, magnesium oxide, calcium, and calcium oxide. Each of the foregoing ingredients can be added alone or in combination with one or more other of the additional components without limitation. The one or more vitamins can be bound or chelated to at least one of the metabolites, preferably such that the bioavailability of the at least one of the metabolites is increased thereby. one or more minerals can be bound or chelated to at least one of the metabolites, preferably such that the bioavailability of the at least one of the metabolites is increased thereby.

Some embodiments can be substantially and/or entirely devoid of probiotic. Some embodiments can be substantially and/or entirely devoid of living microorganism of one or more variety. Some embodiments can be substantially and/or entirely devoid of probiotic and living microorganism of one or more variety.

Embodiments can also comprise a buffering agent mixed with the fermentation product-bound carrier. The buffering agent is preferably mixed with the fermentation product-bound carrier at a ratio between about 1:1 and about 1:20, fermentation product-bound carrier to buffering agent, or vice versa. The buffering agent can comprise one or more granular or powdered electrolytic substances. The buffering agent can preferably be selected from the group consisting of sodium sesquicarbonate, sodium carbonate, and sodium bicarbonate. The buffering agent can comprise sodium sesquicarbonate. The buffering agent can comprise (a mixture of) sodium carbonate and sodium bicarbonate.

In some embodiments, the composition and/or fermentation product can comprise one or more components of a growth medium in which the one or more microorganisms were grown. The composition and/or fermentation product can comprise one or more components of a growth medium in which the one or more anaerobic metabolites were produced (e.g., by the one or more microorganisms). In some embodiments, the composition and/or fermentation product can comprise one or more aerobic metabolites produced by the one or more microorganisms.

An exemplary embodiment can comprise a method of manufacturing a composition, comprising (i) providing a fermentation product and a carrier, as described above, and (ii) forming a combination product by applying the fermentation product to the carrier, preferably at a ratio of approximately 1:1 by weight, more preferably such that the fermentation product binds to the carrier. The fermentation product preferably comprises a liquid suspension medium having cellular material of one or more (single-celled) microorganisms and/or one or more anaerobic and/or optional aerobic metabolites of or produced by the one or more microorganisms disposed therein. In some embodiments, applying the fermentation product to the carrier comprises fluidly applying the fermentation product in a substantially liquid (suspension) form to the carrier in a substantially dry, solid form, preferably at a ratio of approximately 1:1 by weight.

Certain embodiments can further comprise one or more steps selected from the group consisting of (i) mixing the carrier, preferably at a speed between about 10-200 rpm, while applying the fermentation product, (ii) applying a flow of air to the combination product (i.e., the fermentation product-bound carrier, or the microbial fermentation product bound to or adsorbed to a surface of the solid carrier, or absorbed below the surface of the solid carrier) preferably over a period of time between about 12-120 hours and/or until the combination product has a moisture content between about 0.25% and about 20% by weight, (iii) mixing the combination product or fermentation product-bound carrier, preferably at a speed between about 10-200 rpm, while applying the flow of air, (iv) maintaining the combination product or fermentation product-bound carrier at a temperature below about 60° C., more preferably below about 55° C., still more preferably below about 50° C., still more preferably below about 45° C., still more preferably below about 40° C., still more preferably below about 38° C., and (v) maintaining the combination product or fermentation product-bound carrier at a pH between about 2-10, preferably between about 2-8, more preferably between about 2-6, still more preferably between about 2-5, still more preferably between about 2-4, still more preferably between about 2-3, still more preferably between about 3-10, still more preferably between about 3-8, still more preferably between about 3-6, still more preferably between about 3-5, still more preferably between about 3-4, still more preferably between about 4-10, still more preferably between about 4-8, still more preferably between about 4-6, still more preferably between about 4-5.

In some embodiments, at least a portion of the fermentation product physically and/or chemically reacts with and/or binds to the carrier, preferably by adsorption to a surface of the carrier and/or absorption below the surface of the carrier. Embodiments can further comprises mixing the combination product with a buffering agent, as described above, preferably at a ratio between about 1:1 and about 1:20, fermentation product-bound carrier to buffering agent, or vice versa, to form a buffered combination product, the buffered combination product preferably having a moisture content between about 0.25% and about 20% by weight and/or having one or more properties described above. Some embodiments comprise mixing one or more additional ingredients or supplement components with one or more of the fermentation product, fermentation product-bound carrier, combination product, and/or buffered combination product. The one or more additional supplement components can be selected, independently, from the group consisting, independently, of vitamin(s), mineral(s) or trace mineral(s), amino acid(s), plant(s) or plant part(s), plant product(s) or extract(s), herb(s), phytonutrient(s), carotenoid(s), enzyme(s), probiotic(s), lignosulfonate(s), and organic acid(s), one or more minerals or nutrients, preferably selected from the group consisting of zinc, zinc sulfate, zinc oxide, magnesium, magnesium oxide, calcium, and calcium oxide. Certain embodiments can be substantially and/or entirely devoid of probiotic and/or living microorganism of one or more variety.

Some embodiments include packaging the combination product, fermentation product-bound carrier, preferably so as to inhibit substantial absorption or loss of moisture by the packaged combination product.

An exemplary method of manufacturing a composition comprises (i) fluidly applying a substantially liquid fermentation product to a substantially solid earthen carrier, preferably at a ratio of approximately 1:1 by weight, such that the fermentation product binds to the carrier, preferably by adsorption to a surface of the carrier and/or absorption below the surface of the carrier, the carrier preferably comprising one or more phyllosilicate materials, preferably of 1:1 or 2:1 clay mineral variety, the fermentation product preferably comprising a mixture of (i) one or more non-living and/or non-viable microorganisms, (ii) anaerobic and/or aerobic metabolites produced by said one or more microorganisms, and (iii) a liquid suspension medium in which the metabolites were produced by said one or more microorganisms, (ii) mixing the carrier, preferably at a speed between about 10-200 rpm, while applying the fermentation product, (iii) applying a flow of air to the fermentation product-bound carrier, preferably over a period of time between about 12-120 hours and/or until the combination product a moisture content between about 0.25% and about 20%, (iv) mixing the fermentation product-bound carrier, preferably at a speed between about 10-200 rpm, while applying the flow of air, (v) maintaining the fermentation product-bound carrier at a temperature below about 60° C., more preferably below about 55° C., still more preferably below about 50° C., still more preferably below about 45° C., still more preferably below about 40° C., still more preferably below about 38° C., (vi) maintaining the fermentation product-bound carrier at a pH between about 2-10, preferably between about 2-8, more preferably between about 2-6, still more preferably between about 2-5, still more preferably between about 2-4, still more preferably between about 2-3, still more preferably between about 3-10, still more preferably between about 3-8, still more preferably between about 3-6, still more preferably between about 3-5, still more preferably between about 3-4, still more preferably between about 4-10, still more preferably between about 4-8, still more preferably between about 4-6, still more preferably between about 4-5, and, optionally (vii) mixing the fermentation product-bound carrier with one or more nutrient or mineral components, preferably having a moisture content between about 0.25% and about 20% by weight, the one or more nutrient or mineral components preferably being selected from the group consisting of zinc, zinc sulfate, zinc oxide, magnesium, magnesium oxide, calcium, and calcium oxide, and various combination(s) thereof.

The method can further comprise packaging the composition, preferably so as to inhibit substantial absorption or loss of moisture.

A further description of microbial fermentation products, process, ingredients, and the like can be found in U.S. Pat. No. 5,549,728, the entirety of which is incorporated by reference herein.

### Exemplary Mycorrhizal Fungi Components

A wide variety of Mycorrhizal fungi components, including those incorporating a solid, powdered, and/or granular carrier and one or more fungal species bound, adsorbed, and/or absorbed to the carrier, are commercially available.

Illustrative products include:

CXISR GROW; Mycorrhizal Inoculant Fungi by Mycofungi, High Performing Strains, Increases The Number of rhizomes, enhances Stress Resistance, and Increases Plant Yield (57 g/2 oz). 5000 ACTIVE Microbe Propagules Per Gram: Highly concentrated formula, mycorrhizal fungi will protect plants from transplant shock, accelerate uptake, build plant root networks, greatly increase nutrient and water uptake, and can improve the uptake of micro and macro nutrients. High Performance Strain: Our rhizobium inoculant improves plant access to nutrients, 25% higher root colonization, larger, healthier root systems, ideal for indoor and outdoor plants, flowers, vegetables, fruits, lawns. Improved plant yields: Mycorrhizal inoculants have been tested and proven beneficial by thousands of growers around the world with amazing results, increasing yields by 10-45% compared to controls. Designed to achieve bigger, denser, heavier harvests. Saves Fertilizer: premium mycorrhizae improve plant access to nutrients for larger, healthier root systems. Can be used in potting soil, hydroponic growing systems and rockwool. Easy to use: For 1 gallon of plants please use 5-8 grams every 30-40 days. Mycorrhizal Fungi is granular and water soluble, it can be added directly to the roots or added to water and poured in after potting. It can be used in conjunction with compost tea and beneficial bacteria.

Wallace Organic Wonder Premium Mycorrhizal Fungi (1 lb). Super Concentrated Mycorrhizae: Over 300 propagules per gram, 135,000 per pound. The most powerful Mycorrhizal Inoculant on the market! Does not contain any GMO'S. Explosive Root Growth, Increased yields, increased fruiting and flowering, increased nutrient and water absorption. Improves efficiency of nutrients & water. Fast acting, super concentrated! Superior results in field trials. Great for Vegetables, Flowers, Fruits and Herbs. Has helped grow 16-Guinness World Records in gardening. Increases immunity to stress, including drought, disease and pests. Extensive root system Increases plant biomass and yield by up to 300%. Great for container gardening.

Nature's Seed. Am 120 Standard Mycorrhizal Inoculant. Help your plants achieve their greatest potential by applying Am 120 Standard mycorrhizal inoculant. Contains 100% Glomus intraradices. This mycorrhizal fungus has been thoroughly tested and found to be effective in plant establishment and growth enhancement as well as being adaptive to widely varying growing conditions. Glomus intraradices has been used successfully throughout a broad range of environments from boreal sites in northern Canada to tropical sites in South America. Trials conducted by the USGS on a broad range of native western plant species determined that Glomus intraradices either improved germination or increased biomass development in over 70% of the species tested.

In one or more embodiments of the present disclosure, experimental testing of various Mycorrhizal fungi components in combination with biostimulant(s), including but not limited to microbial fermentation (whole culture lysate) products, humic acid(s) and/or fulvic acid, and other known biostimulant(s) successfully confirmed combinations thereof that exhibit beneficial and/or synergistic effects between mycorrhizae and biostimulant(s), enhancing the growth of plant shoot and/or root, as compared to when mycorrhizae or biostimulant(s) are applied alone, and/or enhance the uptake of nutrients, as compared to when mycorrhizae or biostimulant(s) are applied alone.

Nonlimiting examples of Mycorrhizal fungi components are illustrated in Table 1, below.

TABLE 1

| Mycorrhizal | | Mycorrhizal | Inert |
|---|---|---|---|
| source | Species | number | ingredient |
| Mycorrhizae-1 | 1. Rhizophagus irregularis | 500 | Inert carrier |
| | 2. Rhizophagus aggregatus | propagules/g | (99.5%) |
| | 3. Rhizophagus clarus | | |
| | 4. Claroideoglomus | | |
| | etunicatum | | |
| Mycorrhizae-2 | 1. Glomus intraradices | 20,800 | Clay (88%) |
| | | propagules/g | |
| Mycorrhizae-3 | 1. Glomus intraradices | 167,000 | Diatoma- |
| | 2. Glomus mosseae | propagules/g | ceous earth |
| | | | (70%) |

### Exemplary Additional Components

Some embodiments of the present disclosure can include one or more additional components and/or ingredients. For instance, embodiments can include one or more vitamins (e.g., optionally selected, independently, from the group consisting of Vitamin A, Vitamin B complex (e.g., Vitamin B1, Vitamin B2, Vitamin B3, Vitamin B4, Vitamin B5, Vitamin B6, Vitamin B7, Vitamin B8, Vitamin B9, Vitamin B12, Choline), Vitamin C, Vitamin D, Vitamin E, and/or Vitamin K, etc.). An illustrative embodiment can include one or more minerals or trace minerals (or elements) (e.g., optionally selected, independently, from the group consisting of magnesium, calcium, phosphorus, potassium, sodium, boron, cobalt, chloride, chromium, copper, fluoride, iodine, iron, manganese, molybdenum, selenium, zinc, nickel, vanadium, silicon, and/or tin, etc.), one or more minerals or nutrients, zinc, zinc sulfate, zinc oxide, magnesium, magnesium oxide, calcium, and/or calcium oxide. Certain embodiments can include, for example, one or more of copper, manganese, and/or boron. Some embodiments can include one or more additional components selected from one or more: amino acids (e.g., essential and/or non-essential), health supplements (e.g., glucosamine, chondroitin, etc.), plants or plant parts (e.g., berries, leaves, stems, roots, shoots, seedling, cotyledon, etc.), plant products or extracts (e.g., seaweed extracts), herbs, phytonutrients, carotenoids, enzymes (e.g., amylase, xylanase, proteases, phytase, glucanase), probiotics, lignosulfonates, organic acids (e.g., humic acids), etc. Certain embodiments can be substantially and/or entirely devoid of probiotic and/or living microorganism of one or more variety.

Certain embodiments can include one or more surfactants, such as a binding and/or emulsifying agent (e.g., diacetyl tartaric acid esters of mono and diglycerides, edible fats and oils, edible fat-forming fatty acids, ethoxylated mono and diglycerides, methyl glucoside coconut oil ester, mineral oil, mono and diglycerides of edible fats or oils or edible fat-forming acids, monosodium phosphate derivatives of mono and diglycerides of edible fats or oils or edible fat-forming fatty acids, polyethylene glycol 400 (mono and dioleates), polysorbate 80, polysorbate 60 (polyoxyethylene (20) sorbitan monostearate, propylene glycol, sodium stearoyl lactylate, sorbitan mono-stearate with or without polysorbate 60, Tween 80 (T-80), etc., or combination thereof.

Some embodiments can include one or more stabilizing, anti-caking, and/or processing agents (e.g., carrageenan, gelatin gum, guar gum, lecithin, locust bean gum, stearic acid, sodium carboxymethyl-cellulose, sodium silico-aluminate, tara gum, etc.), dust control agents (e.g., mineral oil, paraffin, etc., or a combination of two or more of the foregoing), preservatives (e.g., calcium propionate, sodium benzoate, etc.) and/or other beneficial soil, seed, or plant health ingredients, or combination thereof.

In some embodiments, the method further comprises obtaining the mycorrhizal fungi component by mixing a mycorrhizal fungal component with a spreading or fluffing component, the mycorrhizal fungal component preferably comprising the one or more fungal species bound or adsorbed to a surface of a solid carrier and/or absorbed below the surface of the solid carrier, wherein the solid carrier is preferably selected from the group consisting of diatomaceous earth, clay, one or more phyllosilicates, and one or more naturally-occurring earth components, and wherein the spreading or fluffing component is preferably selected from the group consisting of corn starch, plant starch, plant fiber, diatomaceous earth, one or more phyllosilicates, one or more naturally-occurring earth components, and combination(s) thereof.

Some embodiments can also include one or more (inert) spreading or fluffing agents or component and/or one or more diluting agents or diluents. The one or more spreading or fluffing agents or components and/or one or more diluting agents or diluents can dilute one or more of the product or components or enhance the spreadability or fluff of the product or components (when mixed or combined therewith). The one or more spreading or fluffing agents or components and/or one or more diluting agents or diluents can also or alternatively enhance uniform distribution of the product component(s) (e.g., when applied to seed or soil, seedling or plant). Exemplary spreading or fluffing agents or components and/or diluting agents or diluents can include, without limitation, a vegetable or grain, starch, fiber, etc., such as corn starch, etc., an oil (e.g., corn, canola, olive, etc.), a pre-mix, a vitamin and/or mineral mix, a fertilizer, a pesticide, a phyllosilicate or earthen carrier, or any other suitable product or component-diluting or distributing element.

### Illustrative Mycorrhizal-Biostimulant (Combination) Product or Composition

An illustrative combination Mycorrhizal+biostimulant(s) composition is provided in Table 2, below. The following is an illustrative example only and is not intended to limit the scope of the invention.

TABLE 2

| Ingredient | Amount (g) |
|---|---|
| Humic acids (powdered/granular) - e.g., BorreGro ® HA-2 | 70.0 |
| Bentonite (powdered/granular) | 11.0 |
| Talc (powdered/granular) | 11.0 |
| Microbial fermentation (whole culture lysate) product | 37.0 |
| (liquid) - adsorbed/absorbed to mixture of the humic | |
| acids, bentonite, and talc | |
| Zinc sulfate monohydrate (powdered/granular) | 4.8 |
| Zinc oxide (powdered/granular) | 4.0 |
| Magnesium oxide (powdered/granular) | 2.0 |
| Calcium oxide (powdered/granular) | 0.5 |
| Corn starch (powdered/granular) or other carrier | 1.5 |
| Mycorrhiza bound carrier (clay powder, diatomaceous | 1.5 |
| earth, etc.) | |
| Total, final dry product | 120.0 |

### Illustrative Manufacturing Method

An illustrative method of manufacturing the above Mycorrhizal biostimulant composition is outlined below.
1. Combine talc, bentonite, and humic acid(s) (in a container) and mix thoroughly (illustrative carrier component or mixture).
2. Adsorb/absorb liquid microbial fermentation (whole culture lysate) product to the carrier component or mixture, and dry to suitable moisture content, (either) by:
   a. spray drying liquid microbial fermentation (whole culture lysate) product onto the carrier component or mixture, optionally while mixing and/or applying or allowing air flow, and/or
   b. applying the microbial fermentation (whole culture lysate) product to the carrier component or mixture in multiple (e.g., four) applications, with subsequent drying after each application, as follows:
      i. Add a first amount or quantity (about or up to 25-35%, preferably 30%) of liquid microbial fermentation (whole culture lysate) product to the mixture and mix thoroughly, then air dry (overnight if needed) to moisture content below about 6%, by weight.
      ii. Add a second amount or quantity (about or up to 25-35%, preferably 30%) of liquid microbial fermentation (whole culture lysate) product to the mixture and mix thoroughly, then air dry (overnight if needed) to moisture content below about 6%, by weight.
      iii. Add a third amount or quantity (about or up to 15-25%, preferably 20%) of liquid microbial fermentation (whole culture lysate) product to the mixture and mix thoroughly, then air dry (overnight if needed) to moisture content below about 6%, by weight.
      iv. Add a fourth (final) amount or quantity (about or up to 15-25%, preferably 20%) of liquid microbial fermentation (whole culture lysate) product to the mixture and mix thoroughly, then air dry (overnight if needed) to moisture content below about 6%, by weight.
3. Combine product from Step 2 with powdered nutrients (Zn, Mg, and Ca), and mix, grind/mill resulting mixture, as needed.
4. Optionally, obtain Mycorrhizal fungi component by applying, binding, adsorbing, adsorbing one or more fungal species (or culture) to suitable carrier, such as clay (powder), diatomaceous earth, inert (solid) carrier, etc.
5. Combine Mycorrhizal fungi component with corn starch (or other diluent, spreading, or fluffing agents or components—to enhance the spreadability or fluff of the Mycorrhizal fungi component, or to match or be compatible with the consistency of the mixture from Step 3).
   Preferably, no grinding/milling of the Mycorrhizal fungi component is performed before or after mixing with corn starch, etc.
6. Combine product from Step 3 with product from Step 5 and mix thoroughly.
   Preferably, no grinding/milling of the Mycorrhizal fungi component is performed before or after mixing.

It will be appreciated that in some embodiments, the microbial fermentation product is applied in liquid form to the solid carrier component in a manner that prevents or avoids (i) oversaturating the solid carrier component with the liquid and/or (ii) causing the solid carrier component to become muddy, such as by adding the liquid too quickly.

It will also be appreciated that variations on the foregoing exemplary method, which would be understood by those skilled in the art, are also contemplated herein.

### Exemplary Experimental Results

Illustrative experimental details are provided below. The following are illustrative examples only and are not intended to limit the scope of the invention, which is defined by the claims as granted. Specifically, the experimental results and other examples provided herein demonstrate a wide range of inventive combinations (e.g., products, kits, methods, etc.) that are supported by the present disclosure and not merely those that are illustrated herein. Illustratively, the experimental results and other examples provided herein demonstrate that the disclosed biostimulant composition(s) are expected to synergize (or work in synergy) with any Mycorrhizae product or component, comprising one or more species (or strains) of Mycorrhizal fungi. Indeed, the experimental results and other examples provided herein demonstrate that the disclosed biostimulant composition(s) synergize (or work in synergy) with Mycorrhizae products or components, comprising (1) a single species (or strain) of Mycorrhizal fungi, and/or (2) a plurality of species (or strains) of Mycorrhizal fungi. Illustrative examples of Mycorrhizal fungi include species of Glomus, Gigaspora, Scutellospora, Acaulospora, Entrophospora, Rhizophagus, Claroldeoglomus

The following experimental treatments (or categories) were conducted:
1. Untreated control
2. Biostimulant(s) only
3. Mycorrhizae-1
4. Mycorrhizae-1+Biostimulant(s)
5. Mycorrhizae-2
6. Mycorrhizae-2+Biostimulant(s)
7. Mycorrhizae-3

Table 3, below, provides additional information regarding various illustrative Mycorrhizal products and Mycorrhizal product components, as described herein.

TABLE 3

| Mycorrhizal | | Mycorrhizal | Inert |
|---|---|---|---|
| source | Species | number | ingredient |
| Mycorrhizae-1 | 1. Rhizophagus irregularis | 500 | Undisclosed |
| | 2. Rhizophagus aggregatus | propagules/g | inert carrier |
| | 3. Rhizophagus clarus | | (99.5%) |
| | 4. Claroideoglomus | | |
| | etunicatum | | |
| Mycorrhizae-2 | 1. Glomus intraradices | 20,800 | Clay (88%) |
| | | propagules/g | |
| Mycorrhizae-3 | 1. Glomus intraradices | 167,000 | Diatoma- |
| | 2. Glomus mosseae | propagules/g | ceous earth |
| | | | (70%) |

Illustrative Soil and treatment rates.

Soil and pot: In a 200-cc plastic pot was filled with about 175 cc medium grain perlite. The perlite was double washed with DI water.

Mycorrhiza inoculation rate: 500 propagules/pot.

Biostimulants solution preparation: dissolved 1 g humic acid (powder) and 1 g microbial fermentation product in 100 mL of DI water.

Biostimulants application rate: 1 mL of biostimulant solution/pot containing 10 mg of humic acid (HA) and 10 mg of microbial fermentation product.

### Illustrative Cultivation.

Corn seeds were planted at a depth of 1 cm.

Mycorrhizae and Biostimulants were applied together near to the seed.

Fertilizers rates: Weekly application of 25 mg each of N, P₂O₅, and K₂O/pot. One time application of 100 mg each of Ca and Mg/pot. One time application of 1 mg each of Zn, Mn, and Fe, 0.5 mg each of Cu and B, and 0.05 mg of Mo.

Plants were grown for 4 weeks in a growth chamber. Temperature was 25/20° C.

Roots and shoot biomasses were harvested, dried, and weighed.

### Illustrative Experimental Results

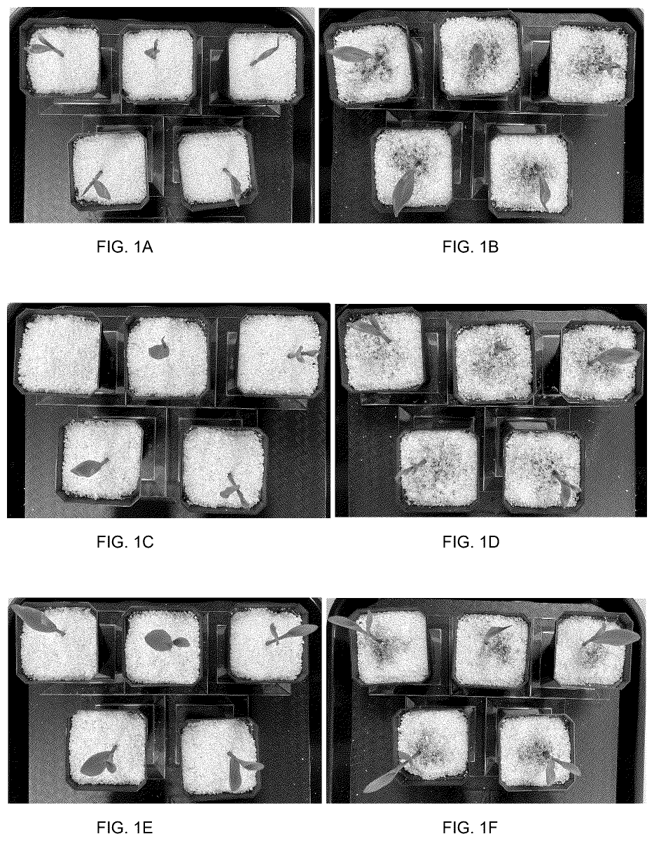

FIGS. 1A-1G depict photographs of separate five (5) replicate trials in which corn plantlets, grown in perlite for 7 days, were untreated (FIG. 1A), treated with biostimulant(s) alone (FIG. 1B), treated with component Mycorrhiza-1 alone (FIG. 1C), treated with biostimulant(s) and component Mycorrhiza-1 (FIG. 1D), treated with component Mycorrhiza-2 alone (FIG. 1E), treated with biostimulant(s) and component Mycorrhiza-2 (FIG. 1F), and treated with component Mycorrhiza-3 alone (FIG. 1G).

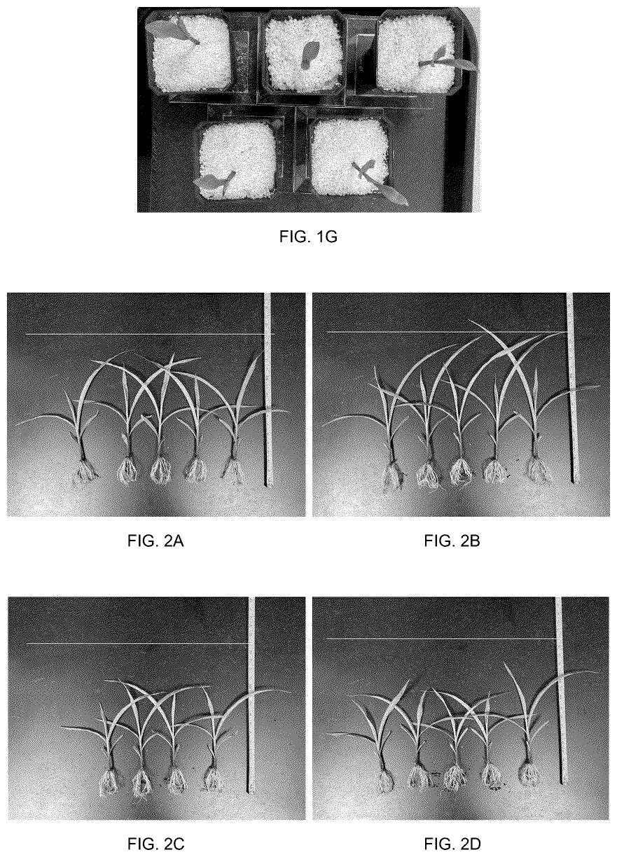

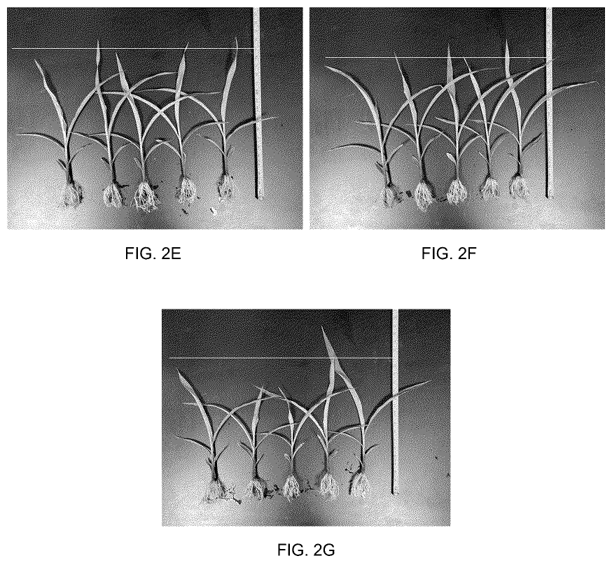

FIGS. 2A-2G depict photographs of separate five (5) replicate trials in which the corn plantlets from FIGS. 1A-1G, respectively, were harvest 28 days after being untreated (FIG. 2A), treated with biostimulant(s) alone (FIG. 2B), treated with component Mycorrhiza-1 alone (FIG. 2C), treated with biostimulant(s) and component Mycorrhiza-1 (FIG. 2D), treated with component Mycorrhiza-2 alone (FIG. 2E), treated with biostimulant(s) and component Mycorrhiza-2 (FIG. 2F), and treated with component Mycorrhiza-3 alone (FIG. 2G). For reference, a horizontal line is drawn at 17 cm in each photograph.

In the illustrative experimental results, “Mycorrhiza-1”, “Mycorrhiza-2”, and “Mycorrhiza-3” are as presented in Table 3.

In the illustrative experimental results, “biostimulant”, “biostimulants”, or “biostimulant(s)” is a microbial fermentation product, comprising: lysed microorganisms; fermentation medium; and fermentation metabolites, illustratively bound (adsorbed/absorbed) to a solid carrier (the carrier can include humic acids (powdered/granular)—e.g., potassium humate and/or fulvic acid, such as BorreGro® HA-2).

Tables 4.1 and 4.3, below, present dry shoot biomass (in grams) of the indicated experimental trials (Replications 1-5, as shown in the photographs of the Figures).

TABLE 4.1

| Treatment/ | Untreated | Biostim- | Mycor- | Mycorrhizae-1 + |
|---|---|---|---|---|
| replication | control | ulant | rhizae-1 | Biostimulant |
| Replication-1 | 0.3527 | 0.3815 | 0.3328 | 0.3297 |
| Replication-2 | 0.3955 | 0.3972 | 0.2848 | 0.2838 |
| Replication-3 | 0.3976 | 0.4106 | 0.3563 | 0.3143 |
| Replication-4 | 0.3556 | 0.3886 | 0.2435 | 0.2968 |
| Replication-5 | 0.3786 | 0.4016 | | 0.4554 |
| Average | 0.3760 | 0.3959 | 0.30435 | 0.336 |
| SD | 0.0213 | 0.0113 | 0.0503 | 0.0690 |

TABLE 4.2

| | | | | Mycor- | |
|---|---|---|---|---|---|
| Treatment/ | Untreated | Biostim- | Mycor- | rhizae-2 + | Mycor- |
| replication | control | ulant | rhizae-2 | Biostimulant | rhizae-3 |
| Replication-1 | 0.3527 | 0.3815 | 0.5476 | 0.5995 | 0.5548 |
| Replication-2 | 0.3955 | 0.3972 | 0.5497 | 0.5642 | 0.4141 |
| Replication-3 | 0.3976 | 0.4106 | 0.4671 | 0.6206 | 0.454 |
| Replication-4 | 0.3556 | 0.3886 | 0.5133 | 0.5345 | 0.6541 |
| Replication-5 | 0.3786 | 0.4016 | 0.5661 | 0.5272 | 0.5168 |
| Average | 0.3760 | 0.3959 | 0.52876 | 0.5692 | 0.51876 |
| SD | 0.0213 | 0.0113 | 0.0395 | 0.0405 | 0.0932 |

Tables 5.1 and 5.2. below, present dry shoot biomass (in grams) of the indicated experimental trials.

TABLE 5.1

| Treatment/ | Untreated | Biostim- | Mycor- | Mycorrhizae-1 + |
|---|---|---|---|---|
| replication | control | ulant | rhizae-1 | Biostimulant |
| Replication-1 | 0.2627 | 0.2782 | 0.2731 | 0.282 |
| Replication-2 | 0.2735 | 0.275 | 0.2446 | 0.2783 |
| Replication-3 | 0.2972 | 0.3066 | 0.2563 | 0.2543 |
| Replication-4 | 0.2836 | 0.2899 | 0.2171 | 0.2476 |
| Replication-5 | 0.2590 | 0.2933 | | 0.3611 |
| Average | 0.2752 | 0.2886 | 0.2478 | 0.2847 |
| SD | 0.0156 | 0.0127 | 0.0236 | 0.0452 |

TABLE 5.2

| | | | | Mycor- | |
|---|---|---|---|---|---|
| Treatment/ | Untreated | Biostim- | Mycor- | rhizae-2 + | Mycor- |
| replication | control | ulant | rhizae-2 | Biostimulant | rhizae-3 |
| Replication-1 | 0.2627 | 0.2782 | 0.3615 | 0.3528 | 0.4007 |
| Replication-2 | 0.2735 | 0.275 | 0.301 | 0.4213 | 0.3087 |
| Replication-3 | 0.2972 | 0.3066 | 0.3285 | 0.4351 | 0.3461 |
| Replication-4 | 0.2836 | 0.2899 | 0.3121 | 0.3525 | 0.4477 |
| Replication-5 | 0.2590 | 0.2933 | 0.3332 | 0.3121 | 0.3965 |
| Average | 0.2752 | 0.2886 | 0.3273 | 0.3748 | 0.3799 |
| SD | 0.0156 | 0.0127 | 0.0231 | 0.0517 | 0.0537 |

Synergy between mycorrhiza and biostimulant(s).

Table 5, below, presents calculation of synergistic effects of mycorrhiza and biostimulant(s) on shoot and root yields of corn.

TABLE 5

| Details | Shoot biomass | Root biomass |
|---|---|---|
| Expected percent biomass weight | 43.77 | 22.87 |
| increase over control (using | | |
| Colby's method*), E | | |
| Observed value or percent biomass | 51.38 | 36.18 |
| increase over control for | | |
| mycorrhiza + biostimulants | | |
| Synergy determination | SYNERGISTIC | SYNERGISTIC |

*Synergistic response calculation (see Colby, S. R. Calculating Synergistic and Antagonistic Responses of Herbicide Combinations. Weeds 15, 20-22 (1967):

Expected response, E=X+Y−(XY/100).

X-percent biomass increase by mycorrhiza.

Y-percent biomass increase by biostimulants.

If observed response >E the combination is synergetic (+).

If observed response <E the combination is antagonistic (−).

If observed response=E the combination is additive.

Table 6.1 and 6.2, below, present the result of one-way ANOVA and the grouping of mean dry shoot biomass using Tukey's HSD test at a significance level of p<0.5 for the indicated experimental trials. SS=Sum of squares; df=Degrees of freedom; MS=Mean sum of squares; F=F−value.

TABLE 6.1
One way ANOVA

| Source | SS | df | MS | F | P-value |
|---|---|---|---|---|---|
| Between | 0.138 | 3 | 0.046 | 48.715 | <0.0001 |
| treatments | | | | | |
| Within | 0.0151 | 16 | 0.0009 | | |
| treatments | | | | | |
| Total | 0.1531 | 19 | | | |

TABLE 6.2

| | Dry shoot weight | |
|---|---|---|
| Treatment | (g/plant) | Grouping |
| Untreated control | 0.376 | B |
| Biostimulants | 0.396 | B |
| Mycorrhiza 2 | 0.529 | A |
| Mycorrhiza 2 + biostimulants | 0.569 | A |

Table 7.1 and 7.2, below, present the result of one-way ANOVA and the grouping of mean dry root biomass using Tukey's HSD test at a significance level of p<0.5 for the indicated experimental trials.

TABLE 7.1

| Source | SS | df | MS | F | P-value |
|---|---|---|---|---|---|
| Between | 0.03 | 3 | 0.01 | 11.057 | 0.000354 |
| treatments | | | | | |
| Within | 0.0144 | 16 | 0.0009 | | |
| treatments | | | | | |
| Total | 0.0444 | 19 | | | |

TABLE 7.2

| | Dry root weight | |
|---|---|---|
| Treatment | (g/plant) | Grouping |
| Untreated control | 0.275 | B |
| Biostimulants | 0.289 | B |
| Mycorrhiza 2 | 0.327 | AB |
| Mycorrhiza 2 + biostimulants | 0.375 | A |

Table 8.1 and 8.2, below, present the result of one-way ANOVA and the grouping of mean phosphorus (P) uptake using Tukey's HSD test at a significance level of p<0.5 for the indicated experimental trials.

TABLE 8.1

| Source | SS | df | MS | F | P-value |
|---|---|---|---|---|---|
| Between | 9.0637 | 3 | 3.0212 | 22.9734 | <0.0001 |
| treatments | | | | | |
| Within | 2.1042 | 16 | 0.1315 | | |
| treatments | | | | | |
| Total | 11.1678 | 19 | | | |

TABLE 8.2

| | Shoot P uptake | |
|---|---|---|
| Treatment | (mg/plant) | Grouping |
| Untreated control | 3.066 | B |
| Biostimulants | 2.905 | B |
| Mycorrhiza 2 | 4.239 | A |
| Mycorrhiza 2 + biostimulants | 4.405 | A |

Table 9.1 and 9.2, below, present the result of one-way ANOVA and the grouping of mean potassium (K) uptake using Tukey's HSD test at a significance level of p<0.5 for the indicated experimental trials.

TABLE 9.1

| Source | SS | df | MS | F | P-value |
|---|---|---|---|---|---|
| Between | 173.5571 | 3 | 57.8524 | 51.5474 | <0.0001 |
| treatments | | | | | |
| Within | 17.957 | 16 | 1.1223 | | |
| treatments | | | | | |
| Total | 191.5142 | 19 | | | |

TABLE 9.2

| | Shoot K uptake | |
|---|---|---|
| Treatment | (mg/plant) | Grouping |
| Untreated control | 9.398 | B |
| Biostimulants | 9.232 | B |
| Mycorrhiza 2 | 14.682 | A |
| Mycorrhiza 2 + biostimulants | 15.650 | A |

### Exemplary Aspects and Embodiments of the Present Disclosure

One or more aspects or embodiments of the present disclosure include:

1. A composition, comprising:
a mycorrhizal fungi component comprising one or more mycorrhizal fungal species; and
a biostimulant component comprising a microbial fermentation product, the microbial fermentation product comprising:
   lysed microorganisms;
   fermentation medium; and
   fermentation metabolites.
      2. The composition of aspect or embodiment 1, wherein the one or more fungal species comprise Rhizophagus sp., preferably Rhizophagus irregularis, Rhizophagus aggregatus, and/or Rhizophagus clarus.
      3. The composition of aspect or embodiment 1, wherein the one or more fungal species comprise Claroideoglomus sp., preferably Claroideoglomus etunicatum.
      4. The composition of aspect or embodiment 1, wherein the one or more fungal species comprise Rhizophagus sp., preferably Rhizophagus irregularis, Rhizophagus aggregatus, and/or Rhizophagus clarus, and Claroideoglomus sp., preferably Claroideoglomus etunicatum.
      5. The composition of aspect or embodiment 1, wherein the one or more fungal species comprise Glomus sp., preferably Glomus intraradices and/or Glomus mosseae.
      6. The composition of aspect or embodiment 1, wherein the one or more mycorrhizal fungal species is selected from the group consisting of Rhizophagus sp., preferably Rhizophagus irregularis, Rhizophagus aggregatus, and/or Rhizophagus clarus, Claroideoglomus sp., preferably Claroideoglomus etunicatum, and Glomus sp., preferably Glomus intraradices and/or Glomus mosseae.
      7. The composition of aspect or embodiment 1, wherein the one or more mycorrhizal fungal species is selected from the group consisting of Glomus sp., Gigaspora sp., Scutellospora sp., Acaulospora sp., Entrophospora sp., Rhizophagus sp., Claroldeoglomus sp., and combinations thereof.
      8. The composition of aspect or embodiment 1, wherein:
the microbial fermentation product comprises a whole culture lysate of a microbial fermentation culture;
less than about 50%, by weight, preferably less than about 20%, by weight, more preferably less than about 10%, by weight, still more preferably less than about 5%, by weight, still more preferably less than about 1%, by weight, of biomass in the microbial fermentation product is living or viable microorganisms;
the microbial fermentation product is entirely or substantially devoid of living and/or viable microorganisms; and/or
the lysed microorganisms comprise lysed lactic acid bacteria, preferably lysed Lactobacillus sp. bacteria, and optionally one or more additional microbial species or strains.
   9. The composition of aspect or embodiment 1, wherein the biostimulant component further comprises a solid carrier component, the microbial fermentation product being adsorbed to a surface of the solid carrier component and/or absorbed below the surface of the solid carrier component.
   10. The composition of aspect or embodiment 9, wherein the solid carrier component comprises one or more phyllosilicates or naturally-occurring earth components.
   11. The composition of aspect or embodiment 9, wherein the solid carrier component comprises talc, bentonite, and/or humic acid(s).
   12. The composition of aspect or embodiment 9, wherein the solid carrier component comprises a plant material or a plant extract.
   13. The composition of aspect or embodiment 9 further comprising at least one additional component selected from the group consisting of:
one or more minerals or nutrients, preferably selected from the group consisting of zinc, zinc sulfate, zinc oxide, magnesium, magnesium oxide, calcium, and calcium oxide; and
one or more spreading agents, preferably selected from the group consisting of corn starch, plant starch, plant fiber, diatomaceous earth, one or more phyllosilicates, and one or more naturally-occurring earth components.
   14. The composition of aspect or embodiment 1, wherein the mycorrhizal fungi component and the biostimulant component are each in a dry or solid form.
   15. The composition of aspect or embodiment 1, wherein the composition has a moisture content less than or equal to about 20%, by weight, preferably less than or equal to about 15%, by weight, more preferably less than or equal to about 10%, by weight, still more preferably less than or equal to about 8%, by weight, still more preferably less than or equal to about 5%, by weight.
   16. The composition of any one of aspect or embodiment 1-15, wherein the one or more fungal species is bound or adsorbed to a surface of a solid carrier and/or absorbed below the surface of the solid carrier, wherein the solid carrier is optionally selected from the group consisting of diatomaceous earth, one or more phyllosilicates, preferably clay, and one or more naturally-occurring earth components.
   17. A method, comprising applying the composition of aspect or embodiment 16 to soil or to a seed, seedling, or plant.
   18. A method of manufacturing the composition of aspect or embodiment 16, the method comprising combining the mycorrhizal fungi component with the biostimulant component.
   19. A method, comprising applying the composition of any one of aspect or embodiment 1-15 to soil or to a seed, seedling, or plant.
   20. A method of manufacturing the composition of any one of aspect or embodiment 1-15, the method comprising combining the mycorrhizal fungi component with the biostimulant component.
   21. A method of manufacturing a composition, the method comprising:
forming a biostimulant component by applying a microbial fermentation product in liquid form to a solid carrier component such that the microbial fermentation product is adsorbed to the surface of the solid carrier and/or absorbed below the surface of the solid carrier; and
mixing the biostimulant component with a mycorrhizal fungi component comprising one or more fungal species.
   22. A method of manufacturing a composition, the method comprising:
forming a biostimulant component by:
   obtaining a solid carrier component, the solid carrier component preferably comprising a dry, powdered, and/or granular composition comprising one or more phyllosilicates, diatomaceous earth, one or more naturally-occurring earth components, and/or humic acid(s);
   applying a microbial fermentation product in liquid form to the solid carrier component such that the microbial fermentation product is adsorbed to the surface of the solid carrier and/or absorbed below the surface of the solid carrier, the microbial fermentation product preferably comprising a whole culture lysate, comprising:
      lysed microorganisms;
      fermentation medium; and
      fermentation metabolites,
   allowing the solid carrier component with microbial fermentation product applied thereto to dry to a moisture content below about 20%, by weight; and
   optionally mixing the solid carrier component with microbial fermentation product applied thereto and having a moisture content below about 20%, by weight, with one or more nutrients, in dry, solid, powdered, and/or granular form, preferably having a moisture content below about 20%, by weight, the one or more nutrients preferably selected from the group consisting of zinc, zinc sulfate, zinc oxide, magnesium, magnesium oxide, calcium, and calcium oxide; and
combining the biostimulant component with a mycorrhizal fungi component in dry, solid, powdered, and/or granular form, the mycorrhizal fungi component preferably having a moisture content below about 10%, by weight, the mycorrhizal fungi component comprising one or more fungal species, preferably selected from the group consisting of Glomus sp., Gigaspora sp., Scutellospora sp., Acaulospora sp., Entrophospora sp., Rhizophagus sp., and Claroldeoglomus sp.
   23. The method of aspect or embodiment 22, wherein the microbial fermentation product is applied in liquid form to the solid carrier component in a manner that prevents or avoids (i) oversaturating the solid carrier component with the liquid and/or (ii) causing the solid carrier component to become muddy, such as by adding the liquid too quickly.
   24. The method of aspect or embodiment 22, wherein the microbial fermentation product is applied in liquid form to the solid carrier component by spray-drying.
   25. The method of aspect or embodiment 22, wherein the microbial fermentation product is applied in liquid form to the solid carrier component in multiple applications, wherein the step of allowing the solid carrier component with microbial fermentation product applied thereto to dry to a moisture content below about 20%, by weight, is performed after each application.
   26. The method of aspect or embodiment 22, wherein the multiple applications include at least four separate applications.
   27. The method of aspect or embodiment 26, wherein a first application applies about 30% of the microbial fermentation product to the solid carrier component, a second application applies about 30% of the microbial fermentation product to the solid carrier component, a third application applies about 20% of the microbial fermentation product to the solid carrier component, and a fourth application applies about 20% of the microbial fermentation product to the solid carrier component.
   28. The method of aspect or embodiment 22 further comprising grinding, crushing, and/or milling the biostimulant component prior to combining the biostimulant component with the mycorrhizal fungi component.
   29. The method of aspect or embodiment 22 further comprising obtaining the mycorrhizal fungi component by mixing a mycorrhizal fungal component with a spreading or fluffing component, the mycorrhizal fungal component preferably comprising the one or more fungal species bound or adsorbed to a surface of a solid carrier and/or absorbed below the surface of the solid carrier, wherein the solid carrier is preferably selected from the group consisting of diatomaceous earth, clay, one or more phyllosilicates, and one or more naturally-occurring earth components, and wherein the spreading or fluffing component is preferably selected from the group consisting of corn starch, plant starch, plant fiber, diatomaceous earth, one or more phyllosilicates, one or more naturally-occurring earth components, and combination(s) thereof.
   30. The method of aspect or embodiment 22 further comprising one or more steps selected from the group consisting of:
cultivating a microbial fermentation culture, the microbial fermentation culture comprising the fermentation medium, microorganisms, and the fermentation metabolites; and
lysing at least some of the microorganisms in the microbial fermentation culture to produce the microbial fermentation product or whole culture lysate.
   31. The method of aspect or embodiment 22 further comprising one or more steps selected from the group consisting of:
maintaining the solid carrier component with the microbial fermentation product applied thereto at a temperature above about 15° C. and below about 60° C. for a first period of time; and
maintaining the solid carrier component with the microbial fermentation product applied thereto at a pH between about 2-10.
   32. The method of aspect or embodiment 22 further comprising one or more steps selected from the group consisting of:
mixing the solid carrier component while applying the microbial fermentation product thereto; and
applying a flow of air to the solid carrier component:
   (i) while applying the microbial fermentation product thereto and/or after applying the microbial fermentation product thereto, and/or
   (ii) over a period of time between about 12-120 hours and/or until the combination product has a moisture content less than or equal to about 20%, by weight.

One or more aspects or embodiments of the present disclosure include any combination of any two or more of aspect or embodiment 1-32.

### CONCLUSION

While the foregoing detailed description makes reference to specific exemplary embodiments, the present disclosure may be embodied in other specific forms without departing from its spirit or essential characteristics. Accordingly, the described embodiments are to be considered in all respects only as illustrative and not restrictive. For instance, various substitutions, alterations, and/or modifications of the inventive features described and/or illustrated herein, and additional applications of the principles described and/or illustrated herein, which would occur to one skilled in the relevant art and having possession of this disclosure, can be made to the described and/or illustrated embodiments without departing from the spirit and scope of the invention as defined by the appended claims. Such substitutions, alterations, and/or modifications are to be considered within the scope of this disclosure.

The scope of the invention is, therefore, indicated by the appended claims rather than by the foregoing description. The limitations recited in the claims are to be interpreted broadly based on the language employed in the claims and not limited to specific examples described in the foregoing detailed description, which examples are to be construed as non-exclusive and non-exhaustive. All changes which come within the meaning and range of equivalency of the claims are to be embraced within their scope.

It will also be appreciated that various features of certain embodiments can be compatible with, combined with, included in, and/or incorporated into other embodiments of the present disclosure. For instance, systems, methods, and/or products according to certain embodiments of the present disclosure may include, incorporate, or otherwise comprise features described in other embodiments disclosed and/or described herein. Thus, disclosure of certain features relative to a specific embodiment of the present disclosure should not be construed as limiting application or inclusion of said features to the specific embodiment. In particular, ingredients and components disclosed in the present application are intended to be independently added or removed from embodiments of the present disclosure, without regard to any example, listing, series, or combination in which they are disclosed. Similarly, method steps disclosed in the present application are intended to be independently added or removed from embodiments of the present disclosure, without regard to any example, listing, series, or combination in which they are disclosed.

Likewise, any steps recited in any method or process described herein and/or recited in the claims can be executed in any suitable order and are not necessarily limited to the order described and/or recited, unless otherwise stated (explicitly or implicitly). Such steps can, however, also be required to be performed in a specific order or any suitable order in certain embodiments of the present disclosure.

In addition, unless a feature is described as being requiring in a particular embodiment, features described in the various embodiments can be optional and may not be included in other embodiments of the present disclosure. Moreover, unless a feature is described as requiring another feature in combination therewith, any feature herein may be combined with any other feature of a same or different embodiment disclosed herein. It will be appreciated that while features may be optional in certain embodiments, when features are included in such embodiments, they can be required to have a specific configuration as described in the present disclosure.

1. A composition, comprising:
a mycorrhizal fungi component comprising one or more mycorrhizal fungal species; and
a biostimulant component comprising a microbial fermentation product, the microbial fermentation product comprising:
lysed microorganisms;
fermentation medium; and
fermentation metabolites.

2. The composition of claim 1, wherein the one or more fungal species comprise Rhizophagus sp., Rhizophagus irregularis, Rhizophagus aggregatus, and/or Rhizophagus clarus.

3. The composition of claim 1, wherein the one or more fungal species comprise Claroideoglomus sp., or Claroideoglomus etunicatum.

4. The composition of claim 1, wherein the one or more fungal species comprise (i) Rhizophagus sp., Rhizophagus irregularis, Rhizophagus aggregatus, and/or Rhizophagus clarus, and (ii) Claroideoglomus sp., or Claroideoglomus etunicatum.

5. The composition of claim 1, wherein the one or more fungal species comprise Glomus sp., Glomus intraradices and/or Glomus mosseae.

6. The composition of claim 1, wherein the one or more mycorrhizal fungal species is selected from the group consisting of Rhizophagus sp., Rhizophagus irregularis, Rhizophagus aggregatus, Rhizophagus clarus, Claroideoglomus sp., Claroideoglomus etunicatum, Glomus sp., Glomus intraradices, and Glomus mosseae.

7. The composition of claim 1, wherein the one or more mycorrhizal fungal species is selected from the group consisting of Glomus sp., Gigaspora sp., Scutellospora sp., Acaulospora sp., Entrophospora sp., Rhizophagus sp., Claroldeoglomus sp., and combinations thereof.

8. The composition of claim 1, wherein:
the microbial fermentation product comprises a whole culture lysate of a microbial fermentation culture;
less than about 50%, by weight, preferably less than about 20%, by weight, more preferably less than about 10%, by weight, still more preferably less than about 5%, by weight, still more preferably less than about 1%, by weight, of biomass in the microbial fermentation product is living or viable microorganisms;
the microbial fermentation product is entirely or substantially devoid of living and/or viable microorganisms; and/or
the lysed microorganisms comprise lysed lactic acid bacteria, preferably lysed Lactobacillus sp. bacteria, and optionally one or more additional microbial species or strains.

9. The composition of claim 1, wherein the biostimulant component further comprises a solid carrier component, the microbial fermentation product being adsorbed to a surface of the solid carrier component and/or absorbed below the surface of the solid carrier component.

10. The composition of claim 9, wherein the solid carrier component comprises one or more phyllosilicates or naturally-occurring earth components.

11. The composition of claim 9, wherein the solid carrier component comprises talc, bentonite, and/or humic acid(s).

12. The composition of claim 9, wherein the solid carrier component comprises a plant material or a plant extract.

13. The composition of claim 9 further comprising at least one additional component selected from the group consisting of:
one or more minerals or nutrients, preferably selected from the group consisting of zinc, zinc sulfate, zinc oxide, magnesium, magnesium oxide, calcium, and calcium oxide; and
one or more spreading agents, preferably selected from the group consisting of corn starch, plant starch, plant fiber, diatomaceous earth, one or more phyllosilicates, and one or more naturally-occurring earth components.

14. The composition of claim 1, wherein the mycorrhizal fungi component and the biostimulant component are each in a dry or solid form.

15. The composition of claim 1, wherein the composition has a moisture content less than or equal to about 20%, by weight, preferably less than or equal to about 15%, by weight, more preferably less than or equal to about 10%, by weight, still more preferably less than or equal to about 8%, by weight, still more preferably less than or equal to about 5%, by weight.

16. The composition of any one of claims 1-15, wherein the one or more fungal species is bound or adsorbed to a surface of a solid carrier and/or absorbed below the surface of the solid carrier, wherein the solid carrier is optionally selected from the group consisting of diatomaceous earth, one or more phyllosilicates, preferably clay, and one or more naturally-occurring earth components.

17. A method, comprising applying the composition of claim 16 to soil or to a seed, seedling, or plant.

18. A method of manufacturing the composition of claim 16, the method comprising combining the mycorrhizal fungi component with the biostimulant component.

19. A method, comprising applying the composition of claim 1 to soil or to a seed, seedling, or plant.

20. A method of manufacturing the composition of claim 1 any one of claims 1-15, the method comprising combining the mycorrhizal fungi component with the biostimulant component.
